(19) United States
(12) Patent Application Publication
(10) Pub. No.: US 2015/0302470 A1
(43) Pub. Date: Oct. 22, 2015

(54) EMBEDDABLE CONTENT

(71) Applicant: INKWHY, INC., Ewing, NJ (US)

(72) Inventors: Janice Dru, Ewing, NJ (US); Michael Duane MOORING, Hamilton, NJ (US); Steven K. KUNTZ, Ewing, NJ (US)

(21) Appl. No.: 14/646,951

(22) PCT Filed: Nov. 27, 2013
(86) PCT No.: PCT/US2013/072370

§ 371 Date: May 22, 2015

Related U.S. Application Data
(60) Provisional application No. 61/730,437, filed on Nov. 27, 2012.

(51) Int. Cl. G06Q 30/02; G06Q 30/08; H04L 29/06

(52) U.S. Cl. CPC G06Q 30/0253; H04L 63/0823; G06Q 30/08

(57) ABSTRACT

Computer readable media, methods, and systems for interactive web advertisements that allow in-place electronic transactions related to an advertisement without disturbing or navigating away from a web page containing the advertisement are described, including a computer system for automatically generating the computer instructions for such advertisements and a computer system for remotely administering such advertisements.

### CROSS REFERENCE TO RELATED APPLICATIONS

This application claims benefit under 35 U.S.C. §119(e) of U.S. Provisional Patent Application No. 61/730,437, filed Nov. 27, 2012, the contents of which are incorporated herein by reference in its entirety.

### BACKGROUND

Hundreds of millions of bloggers, business owners, and other web content creators, have space on their websites. Currently there are advertisement networks, advertisement exchanges, manual advertisement sales, as well as advertising and media companies promoting social network advertisements. As such, bloggers, business owners, and other content creators cannot easily monetize their content and online real estate because they need to register with an advertisement network or exchange, employ a media agency, or manually sell advertisement space. Their e-commerce options are also limited with low conversion rates and advertising return on investment. The value their content and the value of an advertisement can be reduced by requiring a viewer of their content with an embedded advertisement to navigate away from their content to be able to take action on an advertisement. These and other problems are addressed using the inventions described herein.

### SUMMARY

Illustrative examples of the present disclosure include, without limitation, a computer-readable storage medium, a device, and a method. In one aspect, a computer readable storage medium comprises instructions for generating a user interface (UI) of an advertisement (referred to hereinafter also as “ad”) is described, wherein the UI for the ad is presented as a portion, for example, of an internet web page. This advertisement may be an interactive UI that enables the ad viewer to complete an electronic transaction related to the ad, such as a purchase of a product, or a bid in an auction for a service, that is the subject of the advertisement. The ability to complete the transaction in-place without navigating away from the web page containing the advertisement may increase the value of both the web page and the advertisement, and provide a better experience to the ad viewer. Further, the ad itself may be an ad for advertising space somewhere on that web page, which allows for elimination of an intermediary advertisement network, exchange, or media agency. In another aspect, a computer system capable of automatically producing the computer instructions that the user interface of such an interactive advertisement is described. And in another aspect, the method of advertising with such an interactive advertisement is described.

Other features of the disclosure are described below. The features, functions, and advantages that have been discussed can be achieved independently in various examples or may be combined in yet other examples, further details of which can be seen with reference to the following description and drawings.

### BRIEF DESCRIPTION OF THE DRAWINGS

Examples of techniques in accordance with the present disclosure are described in detail below with reference to the following illustrations:

FIG. 1 depicts an example end-to-end system for providing an advertisement hosting service.

FIG. 2 depicts an example embodiment of the application module.

FIG. 3 depicts an example end-to-end process for providing an advertisement hosting service.

FIGS. 4-17 depict examples of a graphical user interface managed by the application module and are executable at user computers.

FIG. 18A depicts an example advertisement widget.

FIG. 18B depicts an example advertising widget embedded within an webpage.

FIG. 19A depicts an example widget before clicking on it.

FIG. 19B depicts an example widget after clicking on it.

FIG. 20 depicts a widget for a pay per period ad space sale.

FIG. 21 depicts a widget for selling an item.

FIG. 22 depicts a widget for auctioning on an item.

FIG. 23 depicts a widget specified to have an image.

FIG. 24 depicts a widget with a format specified.

FIG. 25 depicts a widget with both “Bid” and “Buy Now” options.

FIGS. 26-30 depict a widget through some steps of a bidding process.

FIGS. 31-42 depict a widget through some steps of a buy-now process.

FIGS. 42-49 depict a widget through some steps for bidding on advertising space.

FIG. 50 depicts an example computing system.

### DETAILED DESCRIPTION OF ILLUSTRATIVE EMBODIMENTS

The present disclosure is directed to systems, methods, and computer readable media that enables a website for selling advertising outside of an agency. The disclosed techniques provide an interactive advertisement solution that places control in the hands of advertisers and site owners. However, an agency or third-party could be used with these techniques, including to handle execution on a larger scale. The techniques feature an automated mechanism to generate and approve embeddable advertisements that can be distributed on other sites and networks. In an embodiment, a computing device can be configured to manage a website that automatically generates and approves the embeddable advertisements. The techniques may increase sales through higher conversion rates and integrating the ability to sell products and services, which also allows for seamless tracking.

For example, a website can be configured to allow a user of the website to sell or auction items though an ad on the website, directly bid for advertisement space (ad space) on pages, search advertisement content, and the like. In return, a percentage of purchase earnings generated by a payment gateway of the website may be provided to the website owner and purchaser of advertisement space. The earnings may be a percentage of an amount, such as U.S. dollars, earned on advertisement space sales and/or from products and service sales. The advertisement spaces may be sold to advertisers without third party involvement, which may increase the website owner's earnings. Similarly, the earnings associated with sold products and services may reflect increased conversions due to a reduced number of clicks to get to sale.

Specific details are set forth in the following description and figures to provide a thorough understanding of various embodiments of the disclosure. In the drawings, similar symbols identify similar components, unless context dictates otherwise. Certain well-known technology details, such as computing and software technologies, are not set forth in the following description to avoid unnecessarily obscuring the various embodiments. Those of ordinary skill in the relevant art will understand that they can practice other embodiments of the disclosure without departing from the scope of the subject matter presented herein. Finally, the various techniques described herein can be implemented in hardware, software, or a combination thereof.

Embedded Advertisement System

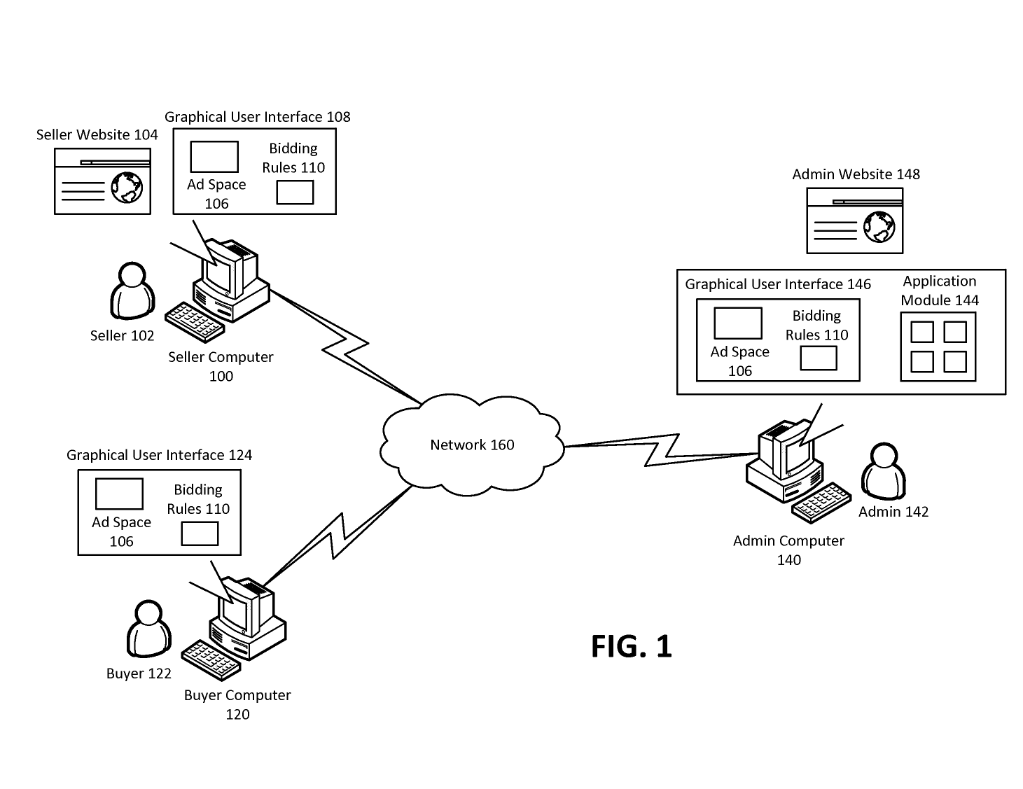

FIG. 1 describes an example end-to-end system for providing an advertisement hosting service. As shown, the system may comprise a seller computer 100, a buyer computer 120, an ad admin computer 140 (also referred hereinafter as admin computer 140), and a network 160 that may interconnect these computers. The seller computer 100 may be associated with a seller 102 of ad space and may be configured to manage a seller website 104 associated with web content that that the seller provides. The seller may be, for example, a blogger or a business owner. The seller website may be hosted on the seller computer or on a server communicatively coupled to the seller computer over a network. In this disclosure, SellerCo may refer to an example seller, and sellerco.com may refer to an example seller website.

The seller may define an ad space 106 on the seller website that he or she wants to sell. The ad space 106 can be defined, for example in the HTML code of the seller website and can be linked to a webpage hosted on an administrator website 148 (also referred to hereinafter as admin website 148 and also as “example.com”). The linkage to the admin website can result in a new browser window being opened, or the admin website content can be embedded within the browser window of the seller's ad space 106 as either a static size or dynamic size upon clicking. The administrator website may be managed by the admin computer 140. The linked website may enable an advertising widget (an interactive ad) to be displayed at the seller website 104 and/or the administrator website as described herein below. The widget may be a user interface comprised of computer instructions that are portable to various computers and environments and may be, for example, embeddable HTML code, and may be linked to the administrator web site. The seller computer 100 may also comprise a graphical user interface to the administrator website. The graphical user interface 104 may be displayed within a web browser that directs the seller computer 100 to the administrator website. Alternatively, the graphical user interface 108 can be provided as an application executable on the seller computer independently of the web browser. The graphical user interface 108 may be configured to receive inputs from a user of the seller computer 100 and to transmit the received inputs to the administrator website. The inputs may allow the seller to upload an available advertisement and bidding rules 110 to the administrator website. The bidding rules 110 may alternately be a purchase price or combination of buy-now purchase price with bidding rules for an auction. The auction may be any type of auction, including an English action, a Dutch auction, or a reverse auction. The advertisement may be a post for selling the advertisement space 106 on the seller website. The bidding rules 110 may define the conditions for selling the advertisement space 106. The advertisement and bidding rules may define features of the widget.

The admin computer 140 may be associated with an administrator 142 and may be configured to manage the administrator website (admin website) 148. In this disclosure, ExampleCo will refer to an example administrator, and “example.com” will refer to an example admin website. The admin website 148 may be hosted on the admin computer 140 or on a server communicatively coupled to the admin computer 140 over a network. An application module 144 may drive the content of the admin website 148, including a graphical user interface 146. In an embodiment, the application module 144 may be integrated with the admin website 148. In another embodiment, the application module 144 may be executed separately from the admin website 148. The application module 144 comprises software for executing a content management system, advertisement widgets, search engine, question and answer webpages, and other components. The content management system may be configured to manage the content of the website. The advertisement widgets may be configured to be linked to advertisement spaces of users, such as the ad space 106 of the seller website. The search engine may be configured to execute a smart or semantic search for content of the admin website 148. The question and answer pages may be configured to post questions and answers received from users. The graphical user interface 146 may be configured to receive inputs from computers over the network, such as the seller computer 100 and the buyer computer 120.

The buyer computer 120 may be associated with a buyer 122 of ad space and may execute a graphical user interface 124. In this disclosure, BuyerCo may refer to an example buyer. The graphical user interface 124 may be displayed within a web browser that directs the buyer computer to the admin website 148. As described above, the direction to the admin website can result in a new browser window or have the content embedded within the browser window of the seller's ad space 106 as either a static or dynamic size upon clicking. Alternatively, the graphical user interface 124 can be provided as an application executable on the buyer computer 120 independently of the web browser. The graphical user interface 124 may transmit inputs received from the buyer to the admin website 148. The graphical user interface 124 may also be configured to interact with the content of the admin website 148 or the seller website 104. For example, the graphical user interface 124 may display available advertisement spaces and their associated bidding rules, including seller's ad space 106 and seller's bidding rules 110. The buyer is able to select an advertisement space, place a bid, and receive a notification whether he or she is the winner of the bid. If the bid is won, the buyer is able to purchase the advertisement space. The graphical user interface allows the winner to define an advertisement to be displayed in the advertisement space 106. The defined advertisement is linked to the widget and displayed at the seller website 104 in the defined advertisement space 106. A user or viewer of the seller's web site may be presented with buyer's ad, and that user or viewer may then purchase a product from buyer using the ad widget. Note that this purchaser is potentially any internet user or viewer and is separate from the ad buyer.

The network 160 comprises a communications network of any type that is suitable for providing communications between the computers and may comprise a combination of discrete networks, which may use different technologies. For example, the communications network comprises a cellular network, a WiFi/broadband network, a local area network (LAN), a wide area network (WAN), a telephony network, a fiber-optic network, or combinations thereof. In an example embodiment, the WiFi/broadband network comprises the Internet and any networks adapted to communicate with the Internet. The communications network may be also configured as a means for transmitting data between any of the components of the end-to-end system.

To illustrate a mechanism of operating the end-to-end system of FIG. 1, the following example is provided. The seller 102 may be a florist and the seller website 104 may be a website for selling flowers. The florist website may comprise a banner that is located at its top and that is available for advertisement. The florist may log in to the admin website through the graphical user interface 108, post an advertisement for selling the banner as an advertisement space 106, and define that bidding rules 110 include that bidding for the space starts at $9.95 and that the winning advertisement will be displayed within the banner for a time period specified by the seller, for example, displayed for a month. The application module 144 may add the space to its managed content, generate a widget, and return an embeddable script that the florist may incorporate into the florist's website (e.g., copy and paste the script into the HTML code of the florist's website). The florist's website may display the widget in the banner advertisement space. The buyer 122 may be a gardener that provides gardening services and that may be interested in advertising for his or her services. The gardener may log in to the admin website through the graphical user interface 124, search for advertisement spaces for sale 126, and find the space associated with the florist. Additionally, the gardener may directly find the ad space by connecting to the florist website without first visiting the administrator web site. The gardener may purchase the space by clicking on the widget, agreeing to the terms and conditions of the sale, and submitting a payment of $9.95. The gardener may also define his or her advertisement that will be displayed in the banner of the florist's website. For example, the gardener may drag and drop a box from a window running on the buyer computer 120 into the graphical user interface 124. The box may define images, information, and the like about the gardening services. The application module 144 may update the ad space 106 with the gardener's advertisement. The application module 144 may also allow the seller 102 to communicate with buyer 122. The application module 144 can include adjustable settings to give the seller 102 or buyer 122 the approval rights to remove the ad. The application module may also automatically transmit a percentage of the $9.95 to the florist. Further, the application module 144 may monitor traffic at the florist's website, the number of clicks on the gardener's website, and the number of purchases made following the clicks. The application module may record these metrics and provide a summary to the florist and the gardener. The application module may also track the corresponding earnings associated with these metrics and return a percentage thereof to the florist and the gardener. When the month has elapsed, the application module may automatically remove the gardener's advertisement from the florist's website. Further, the application module, around the month deadline, may remind the florist and the gardener that the advertisement is about to expire and provide them both with options to renew the sale of the advertisement.

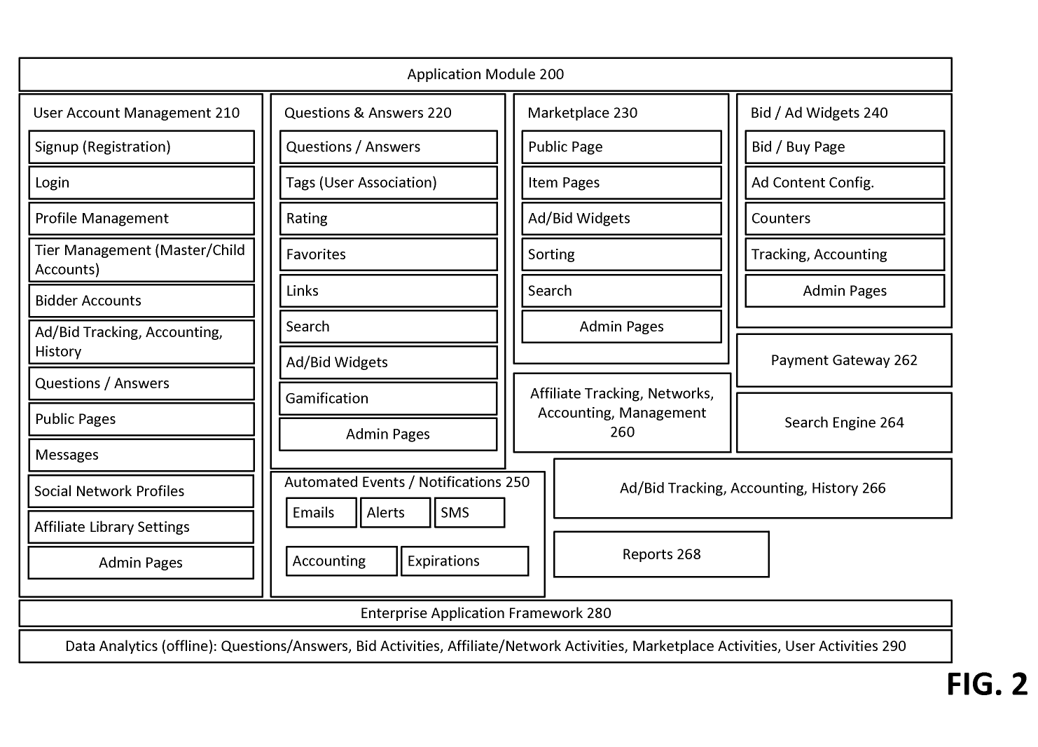

FIG. 2 describes an example embodiment of the application module 200. The application module 200 comprises various components. A user account management 210 component can be configured to manage a profile associated with a user. A questions and answers 220 component can be configured to upload and tag questions and answers from users. A marketplace 230 component can be configured to manage content such as webpages of the admin website. A bid/ad widgets 240 component can be configured to link advertisement spaces to a bid/buy webpage. An automated events/notifications 250 component can be configured to automatically transmit information about a sale of an advertisement to a seller and a bidder associated therewith. An affiliate tracking, network, accounting, and management 260 component can be configured to manage a user account that comprises a plurality of users or affiliates. A payment gateway 262 component can be configured to receive payments from users. A search engine 264 component can be configured to search content of the admin website. An ad/bid tracking, accounting, and history 266 component can be configured to track user activities associated with an advertisement. A reports 268 component can be configured to generate metrics based on the tracked activities. The reports and the generated metrics may be available for an offline analysis. For example, this data may be made available to a data analytics 290 application that runs independently of the application module 200. These various components may be accessible to an administrator and may be programmed as computer readable instructions. The instructions may be defined based on an enterprise application framework 280, which may be a standard or a custom framework.

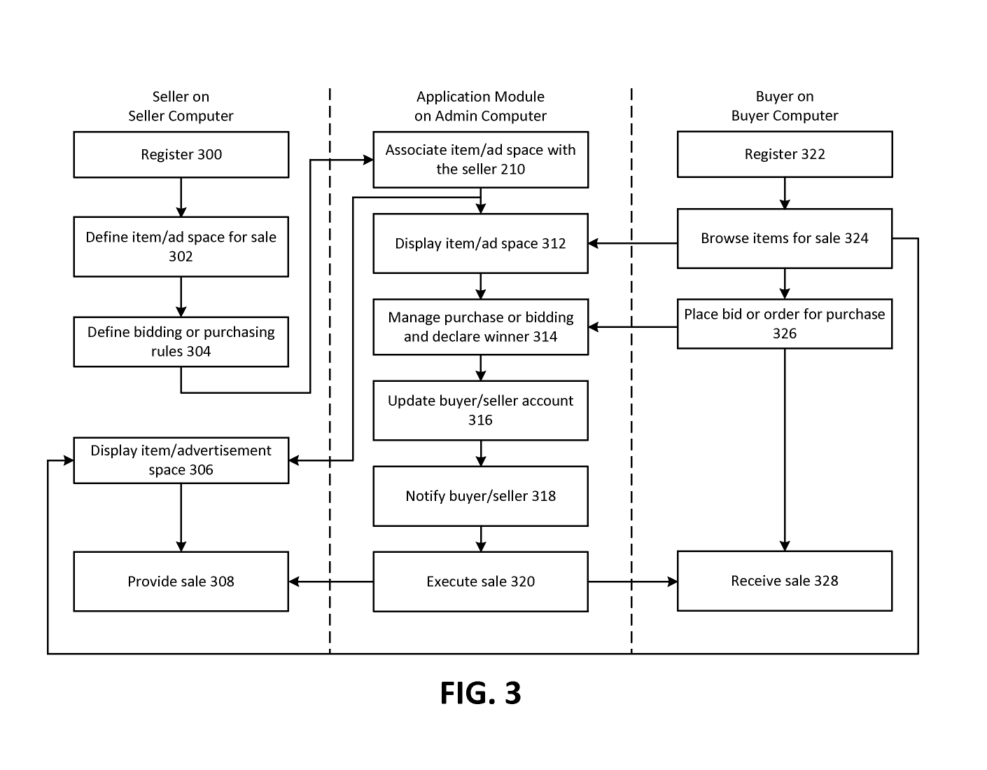

FIG. 3 describes an example end-to-end process for providing an advertisement hosting service. The seller may register 300 and sign-in with the admin website (“example.com”). The registration may be executed though a graphical user interface and may comprise generating a profile associated with the seller. The profile may comprise login credentials such as a user name and a password, a tier management that defines a master and a plurality of child accounts associated with the profile, bidder accounts that are configured to allow the seller to set up advertisement sales, tracking of advertisements and bids and the associated accounting and history, questions and answers generated or searched for by the seller, public pages accessible to the seller and other users, messages posted for or generated by the seller, social network profiles associated with the seller, and library settings of affiliates of the seller such as affiliates associated with the plurality of child accounts. The login credentials can be managed by a third-party authentication system and can be the same as credentials used by the seller to log into a personal webpage at a social network.

Once the seller is registered and authenticated, the seller may further define an item 302 for sale using the graphical user interface. The item may be an ad space on the seller website. The ad space may be defined in any web browser language, such as HTML/CSS, Javascript, etc. The ad space may be linked to a webpage of the admin website. The webpage may be configured to generate a widget associated with the advertisement space. The seller may define parameter of the ad space in the widget.

The seller may also define the bidding rules 304 using the graphical user interface. The webpage may comprise fields to enter the rules. The rules may comprise start and end dates of the sale, a reserve sale price, a buy-it-now/purchase option, minimum and maximum acceptable bids and increments thereto, a period during which a winning advertisement will be displayed in the space, renewal information, types or categories of acceptable advertisements, and the like. Once the various parameters of the sale are described, the application module may complete the definition of the widget. The seller website may display the widget 306.

The application module may associate the ad space and bidding rules with the seller profile 310. The application also adds information related thereof to the sale or auction, wherein the sale or the auction comprises the ad space and the bidding rules. For example, the added information may define various parameters for displaying 312 the sale on the admin website. The parameters may include a category under which the sale will be displayed, search terms that can be used to retrieve the sale (which could include the items for sale in step 324, ad displayed in 306, or item/ad space displayed in 312), a webpage that will host the sale, a description of the rules, a description about the seller website, a description about the seller, and the like.

The buyer may also register 322 and sign-in with the admin website. The registration may be similar to the registration of the seller. Once logged-in, the buyer may execute the user interface to browse items for sale 324. For example, the buyer may search for available advertisement spaces using search terms. The buyer may find the sale of ad space by the seller. The application may display the sale to the buyer over the graphical user interface the parameters associated therewith. The buyer may place a bid 326 to purchase the advertisement space. The bid can be placed through the graphical user interface. In an embodiment, the buyer connects directly to the seller website and clicks on the displayed widget advertising the sale 306. Once clicked, the buyer may be required to sign-in/register with the admin website. The buyer can then place the bid on the advertisement space. In this embodiment, point-of-sale, the bidding, and payment transactions may occur outside of the admin website.

The application module manages the bid 314. For example, the application module ensures that the bid conforms to the bidding rules. The application module may also notify the buyer and the seller about a status of the bid. The status may be whether the bid conforms to the rules, whether the bid is the highest received bid, whether the bid is a winning bid, whether the bid is a losing bid, and the like. The application module may also declare a winner of the bid. For example, the winner may be determined based on a criteria set in the bidding rules. The criteria may be a purchase price and a deadline. Thus, for instance, when the buyer is associated with the highest price and the time when the bidding period expires, the application module declares the buyer as the winner.

The application module may also update the buyer and seller profiles 316. The updates may include a history associated with the sale, such as the number of bids, the winning bid, and the like. At the conclusion of the bidding period, the application module may notify the seller of the winning bid 318, if any. The application module may also notify the winner. If the buyer did not win the auction, the buyer may be notified of the result and of the winning bid. The notifications may be made via any form of electronic communication such as email, text message, phone call, and the like. The address of the notifications can be derived from the user profiles. In an embodiment, the notifications are posted as messages within the user profiles.

Once concluded, the application module executes the sale or the auction 320. For example, the application module directs the seller via the graphical user interface to provide the sale 308. Similarly, the application module directs the buyer via the graphical user interface to receive the sale 328. The application module may manage a payment from the buyer to the seller. The application module may also provide an interface to the buyer for defining the advertisement to be displayed at the seller website. The interface can be configured to provide various tools to the buyer. The tools may include, for instance, drag and draw features, selectable shapes, colors, and sizes, options to upload advertisement graphics, and other graphics editing tools. The buyer may execute the tools at the graphical user interface to define the advertisement that will be displayed at the seller website.

The application module may validate the generated advertisement to ensure that it meets the bidding and other rules. For example, the other rules may prohibit advertisements that may display profane content. The application may also process the generated advertisement to link to and display on the advertisement space. Other post-sale services may also be associated with the sale and be executed by the application module. The services include monitoring traffic at the seller website and tracking a number of clicks on the advertisement and a number of sales made by the buyer based on the clicks or based on the money transactions and/or other measureable actions occurring directly inside the advertisement.

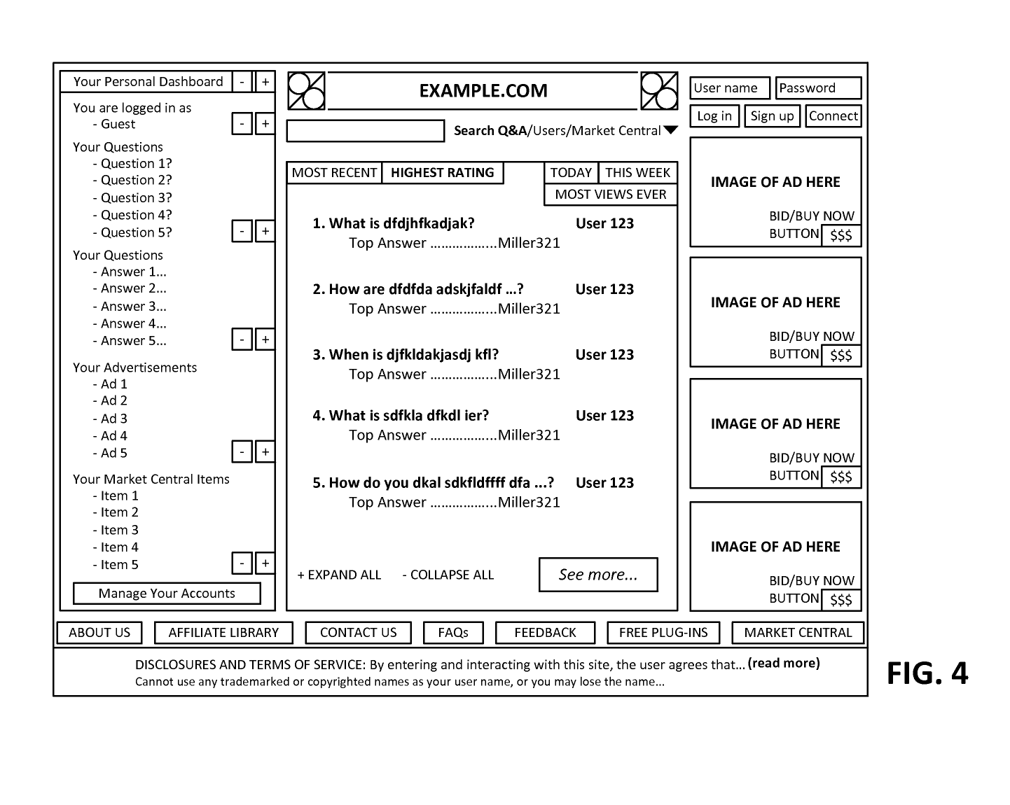

FIGS. 4-17 provide examples of a graphical user interface managed by the application module and are executable at user computers. The user computers may include the buyer and seller computers of FIG. 1. The graphical user interface may be provided as web pages displayed through web browsers at the user computers. Alternatively, the user interface may be provided as an application executable at the user computers independently or along with the web browsers.

Ad Administrator Website

FIG. 4 presents a home page of the administrator website (example.com). The home page may be displayed at the graphical user interface and may comprise:
1. Search function: Key words—be able to search questions and answers (Q&As) as well as by users. The search function of the Q&As can also be linked to the searching of items for sale and ads as described above. The search function may also be connected to other web crawlers and searching other websites to pull into the Q&As, provided the search and display of content from other sites is permitted. “Smart” or “Semantic” search more words in multiple languages, word misspellings, visual matches, and other factors will bring up any Q&As that are closer to what the user is asking, and search results will show up based on popularity of the Q&As, but can toggle results based on sort criteria outlined in point 8 directly below in this section;
2. Non-logged-in user can ask (or answer) a question as a guest. The default user page may be for a “guest;”
3. Master account (for example belonging to SellerCo or BuyerCo) will be able to remove inappropriate questions and answers;
4. Auto-flag certain entries based on profanity, etc., requiring a reviewer to approve prior to going live;
5. Top number (e.g., five) of questions (show the highest rating) with just a single line to show the (beginning of) the question and a single line showing the (beginning) of the highest rated answer. Questions and answers will be tagged by which user asked/answered and will be linked to their user page. Keep a record of what the top questions were over time, for tracking and measurement purposes—and value of historical data. Click “see more” to drop down view on page—click on actual question to go to the “Question Page;”
6. Click on the User ID next to each answer or question to view the “User Page;”
7. Click on “See more” to drop down view to show more questions;
8. Be able to toggle the screen to show results sorted by highest rating, most recent, most views today, most views this week, most views this month, most views this quarter, most views ever, and also be able to view unanswered questions sorted in chronological order. The chronological order may show the question that has been unanswered for the longest period of time first;
9. User can log in or sign up on page; In this disclosure, USER (all caps) will refer to a particular user of the administrator website, and such users include sellers, such as SellerCo, buyers, such as BuyerCo, and other users of the administrator web site such as ad viewers that neither sell nor buy ad space.
10. Page shown will feature three “Ad-bidding Widgets” on the right hand side of the page:
   a. A Donation Widget (allows users to donate $1 or select a larger amount to donate to the “featured” organization. One hundred percent of these donations will be given to the organization;
   b. A “Marketplace” link that will go to the Marketplace page. The bidding option may disabled under this link;
   c. A default advertisement for purchasing the advertisement-bidding Widget that may define a space available up for bid;
11. Links to other major pages of the site and a counter showing Year, Quarter, Month, Week, Day, and Total views, top performing Ads (leader board for most viral ad widget and most engaged/interacted widget), products (leader board for most products sold), users, answers (in their own context) and questions (best questions/best rates answers). The data of the counter may be saved and shared in a quarterly/annual “report” of popular questions and users;
12. Keep a tally and records of these counters over time for reporting and measurement reasons. The IP addresses of visitors may be saved. Anonymous usage patterns of the users may be saved to improve the website's simplicity & effectiveness;
13. Include “Like/Tweet/Share/Email” icons or links on all pages;
14. Once USER is logged in, show the link to “Manage Your Account Page;” and
15. Clicking on top bar brings the user back to this main home page. Clicking on “guest” or the user name at the top will direct to the “User Page.”

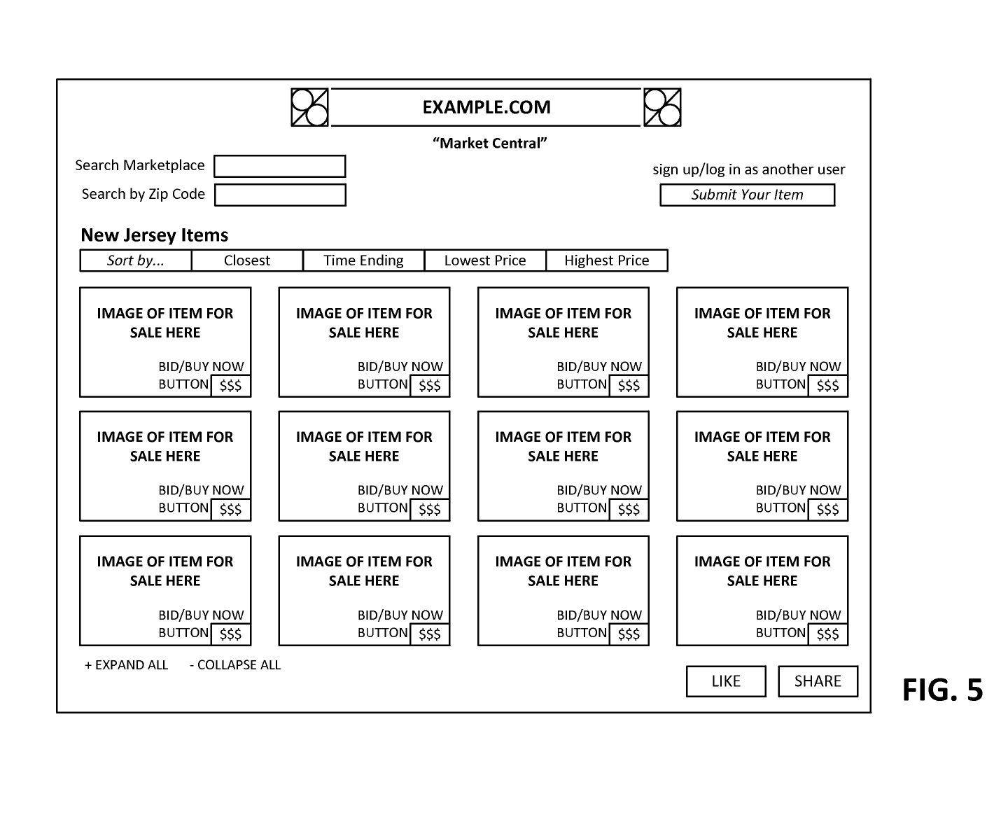

FIG. 5 presents an availability page of the admin website. The availability page may be displayed at the graphical user interface and may comprise an open advertisements page and a marketplace page. The open advertisements page may comprise:
1. A page that shows all the pages that have advertisements that are up for bid;
2. Sort by advertisement pricing, which may show advertisements based on the price they sold in the last period of bidding; and
3. On the back-end (not visible on the availability page, but visible to the master account holder, i.e., SellerCo or BuyerCo), keep a record of all advertisements that have sold (e.g., back-end—images, links, sale prices, and information about the page where it was sold and the person/entity that purchased the space).
   The marketplace page may comprise:
1. Space, or links to webpages, where advertisement-bidding widgets are featured—in order to sell items based on location (including zip codes) and topics (e.g., a marriage of Craigslist and eBay, where people can set bids for items that would get picked up locally or could get shipped);
2. Ability for a user would submit an advertisement to place on the Marketplace Page that would have to be approved before it can show up (review for image and link to protect against spam)—items and users can also get “flagged” as scammers;
3. Once the advertisement gets approved, it would show up on the page—and stay up there until it gets bought or the user takes it down;
4. Once the item is sold, the advertisement will get taken down;
5. Users will be able to settle disputes through, for example BuyerCo or SellerCo. ExampleCo will not be liable for any losses; and
6. Guests and users will be able to search the Marketplace for items based on keywords, as well as tags (zip code or country locations and what “category” the item would be classified as—e.g., selling User Names, books, advice, etc.).

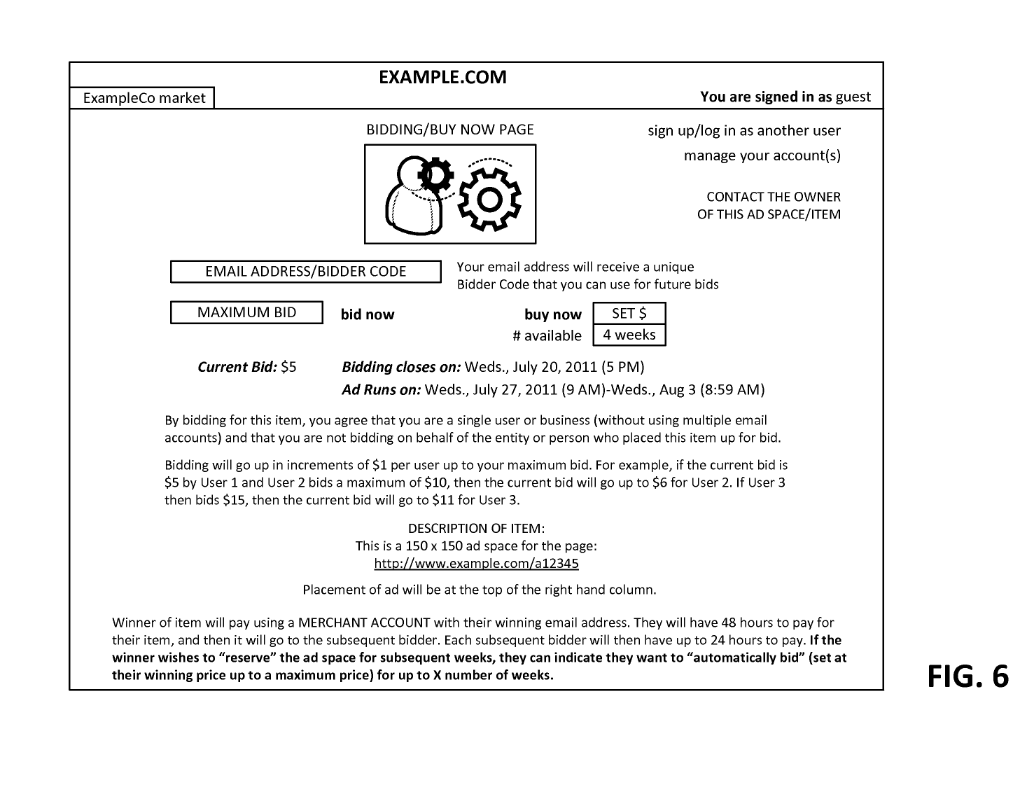

FIG. 6 presents a bidding page of the admin website. The bidding page may be displayed at the graphical user interface and may comprise:
1. Settings to allow different features to be changed: size of image and whether it will be a buy it now (with 1 or multiple instances) or a bid now view;
2. Secure bidding (bidder codes associated with an email address and password) and secure codes to be able to bid;
3. A tie to merchant accounts (winning bidders should be able to pay via, for example, PayPal or credit card);
4. A tie to a “master account” and settings to change percentage paid out to, for example, BuyerCo, SellerCo, or ExampleCo or to the USER based on the placement of the advertisement and the USER level of service (e.g., upgraded users may be paid a higher percentage of their advertisement dollars or use the widgets on their own pages with a lower percentage paid to BuyerCo, SellerCo, or ExampleCo on sold items);
5. Allowing for “automatic” bidding features, such as entering a maximum bid and/or a recurring maximum bid for a space in the future (enables automatic renewal of an ad space purchase);
6. Notifying bidders of when their bid is outbid (notification might not come from ExampleCo, but, on white-labeled pages where the widget is featured; the USER will have the option of making it “appear” as though the notifications are coming from them (e.g., jsmith@sellerco.com);
7. Providing bidders with a secure account management page to view all the advertisements they are currently bidding on and have won or lost in the past. Show statistics associated with these advertisements. Note: an ad space that is won may go to a page that is set up with an advertisement widget selling a specific item. This is to encourage people who are posting advertisements on the “Marketplace” to buy advertising that links to their items there;
8. Notifying a winning bidder of the price that they won the ad/item at and request payment by a certain time period (letting them know that if they do not respond, the offer will be withdrawn and extended to the next highest bidder, or if no payment is made the ad space will default to a random or selected affiliate link advertisement);
9. If a winning bidder is a repeat non-paying offender, suspend or flag their bidding account; and
10. Allow bidders and sellers to communicate with each other through a system that redirects their questions to personal email addresses securely (ExampleCo would retain a record of any communications to go through the system for legal purposes).

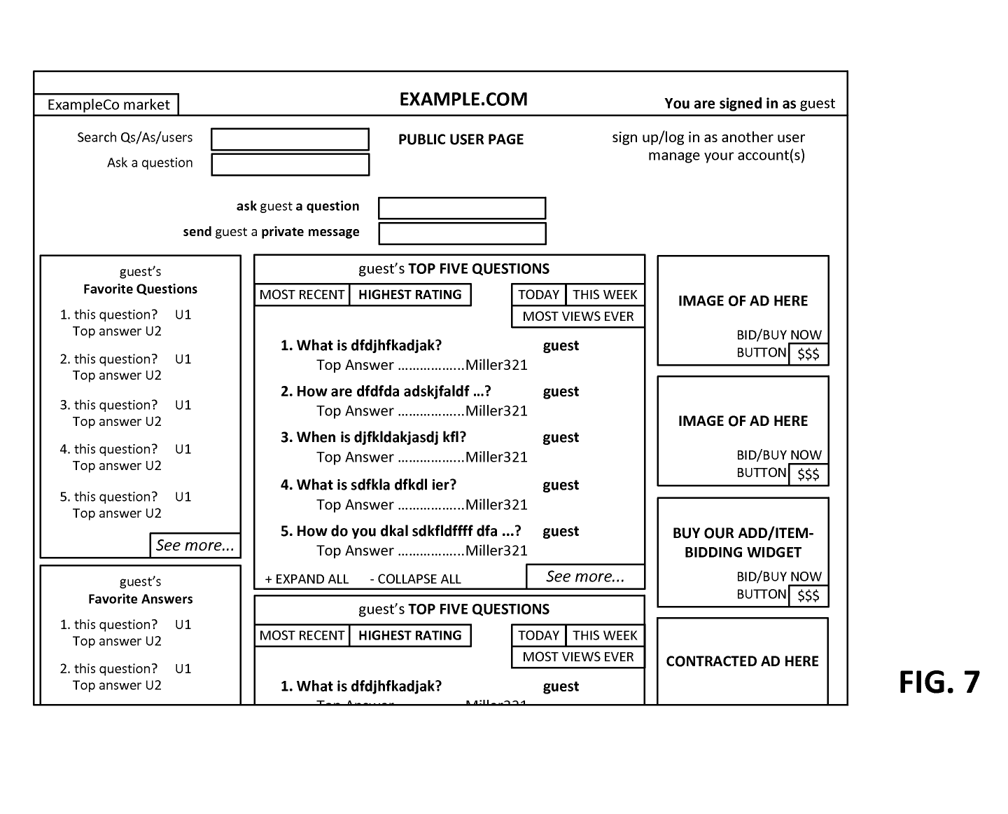

FIG. 7 presents a user page of the admin website. The user page may be displayed at the graphical user interface and may comprise:
1. Show User's Top Questions and Top Answers (e.g., top 5 questions and top 5 answers). Allow the user to sort the same way that questions are described on the Home Page section, and ability to see more;
2. Show aggregate, linked, and unlinked results in terms of the user's top questions and answers (master account in any combination with sub-accounts—together or separate);
3. Allow private settings and public settings. For example, the logged-in user can view all of their top questions and top answers associated with all their accounts or just on the account that they select, but the public view could show just the questions associated with the single USER name with the option of publicly showing that it is linked to one or more of the other user accounts;
4. Guests can select favorite questions and favorite answers (on the question page, mark it as a favorite next to the question or the answer—with a star—as a way to track what questions they like); their favorites will show up on their public user page, also sorted by most popular, etc.—but allows users to reorder their favorites manually so that the top questions and answers that show up are in their order of preference as a default;
5. Give the users the option of sending the guest a private message and give the users the option of hiding this feature. The message would be stored by on the system and forwarded to the user; and
6. Three advertisement-bidding widgets should appear on every user page and are linked to the user.

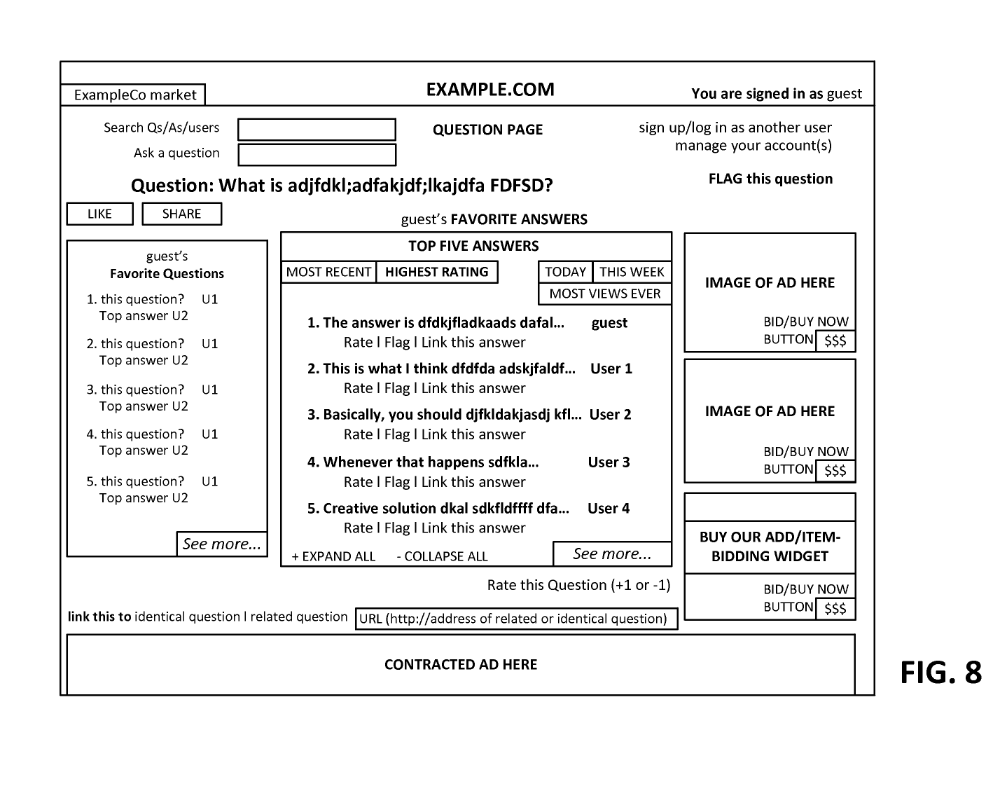

FIG. 8 presents a question page of the admin website. The question page may be displayed at the graphical user interface and may comprise:
1. Show top number (e.g., five) of answers associated with question (answers can also be toggled using the same sort criteria as described on the Home Page and on the User Page;
2. Drop down to see more within the page;
3. Click on an “Expand All/Collapse All” button to be able to view all answers in full or to shorten it to a view that shows only the first line of each question and answer.
4. Give logged in users the ability to flag a question (must check off a reason for flagging) or an answer, and also to give each question or answer a +1 or a −1 rating;
5. Be able to identify other pages on the COMPANY site that are an identical or related question;
6. Show a list of related questions;
7. Collapse identical questions into a single question (i.e., all answers from identical questions will be populated under the FIRST question that was asked). A user should be able to “Unlink” a question that was marked as identical as well (or be notified that their question was linked as identical and “confirm” before the question gets merged with the prior asked identical question);
8. Users should be able to mark questions and answers as a favorite (e.g., clicking on a star button);
9. Three ad-bidding widgets should appear on every Question Page (same placement as on the User Page and Home Page—and be linked to the user who asked the question);
10. Answers should also be linked to the user who answered; and
11. Any user can submit as many answers as they like to their own questions, be able to edit and remove the answers they submit, and edit the questions they ask. (They cannot remove a question once it's asked, but they can submit a “request to remove” with a reason. Users can also “suggest edits” to the user who asked the question or provided an answer.)

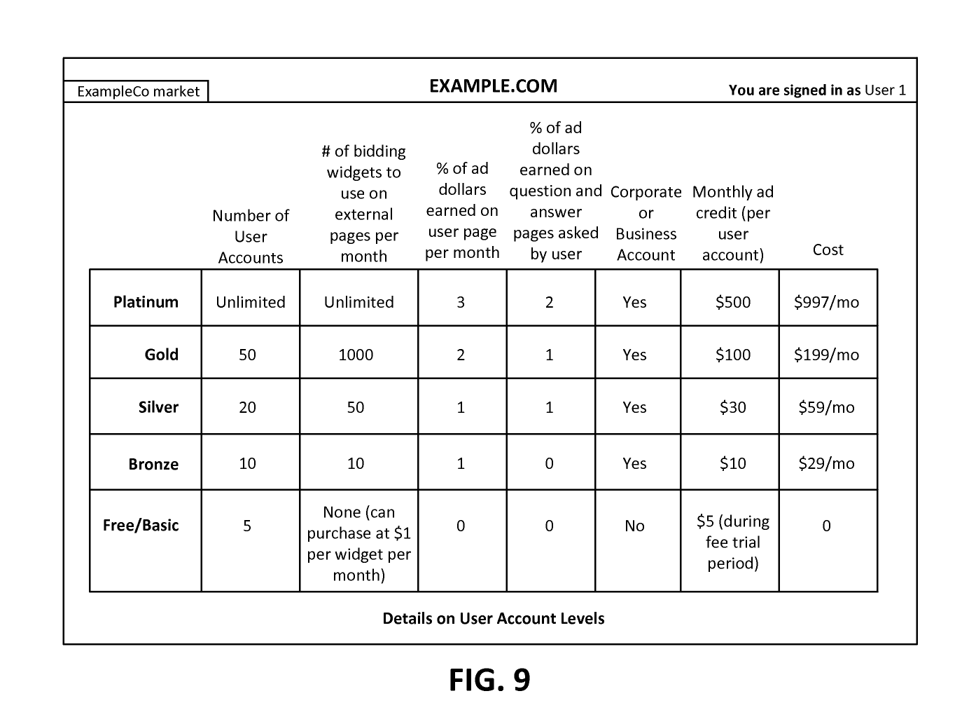

FIG. 9 presents a user sign-up page of the admin website. The sign-up page may be displayed at the graphical user interface and may comprise:
1. Simply enter an email address and password to register a User Name;
2. If a User Name is taken, the user will be asked to select another one or will be offered alternatives;
3. If an email address is already in the system, the user will be asked if they would like to link the account to another Master Account—and must enter the password associated with that email address to link up the new User Name they are creating. Once they have signed up a subsequent User Name, it can be set as the new Master Account;
4. Make sure User has read and agreed to Terms of Service (e.g., at the top of the page, bullets in PLAIN LANGUAGE that are key points are displayed, the full legal disclosure is displayed at the bottom of the page) and has a security feature to ensure that it's a person setting up a new account; and
5. Any user who sets up a master account will also automatically be assigned a unique “Bidder Code” that can be used to bid on advertisement spaces (For users who are bidding on an item on an external site, they can have separate bidder codes set up to bid on items that are shown on external pages, but they can link their bidder accounts as well so that they could bid as a single user anywhere.)

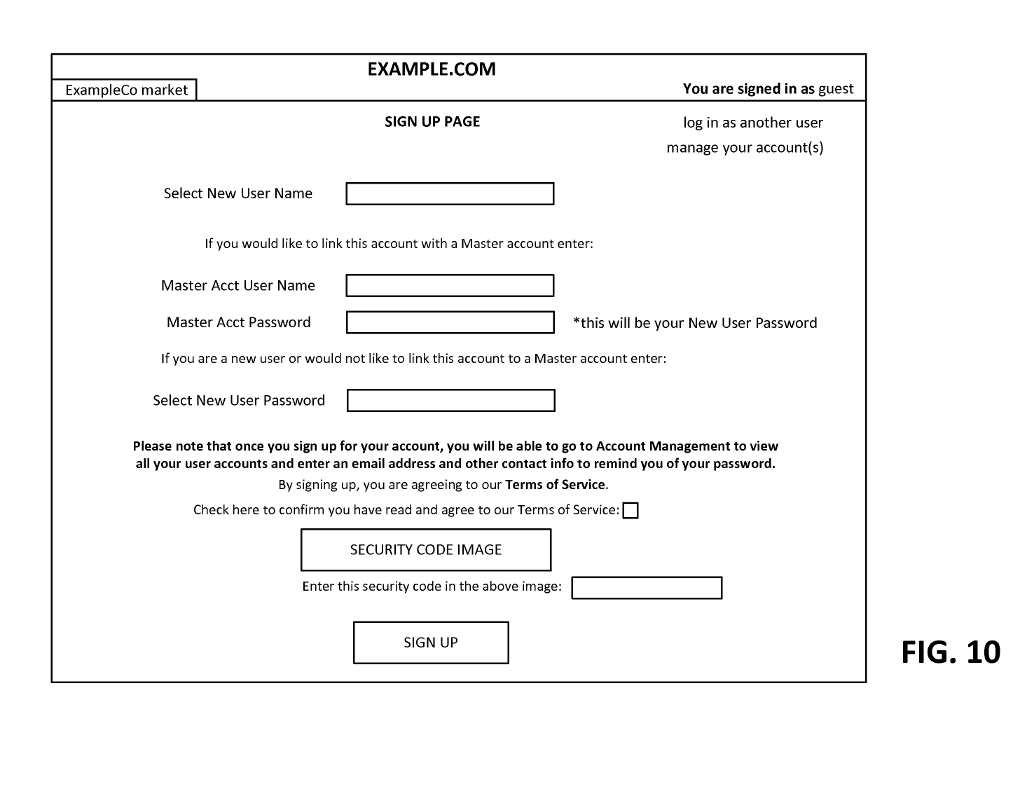

FIG. 10 presents a master account page of the admin website. The master page may be displayed at the graphical user interface and may comprise a master account management page, an advertisement-bidding/affiliate link structure page, and an affiliate link library page. The master account management page may comprise:
1. Change linked settings and order of views;
2. Be able to toggle between user accounts or link two or more together publicly so that questions on linked accounts may show up on a single page (e.g., Mommyoftwo and Events are two Account names that are publicly linked, so when another User clicks on the Mommyoftwo link, they would see Q&A results for both Mommyoftwo AND Events and be able to toggle through them as a unit). It would show on the Mommyoftwo User page that Events is a sub-linked account;
3. User can link accounts by entering another User Name and Other Password—the initial password and email account will then be dropped—in order to allow another User Account to be moved to another Master Account; the initial email address will be notified that another User is asking to migrate the User Account and would need to accept the merge. Once merged, it can only be moved back using another merge to another Master Account;
4. Set up a way to “Sell” User Names—i.e., when the User is notified that one of their accounts is being linked to another Master Account, we can have a page set up on the “Marketplace” for that User to sell their User Name via bid or buy-it-now options.
5. The Manage Your Account Page master view will links to individual views of the “Individual Account Management Pages;” and
6. As described in Advertisement-bidding/Affiliate Link structure, the Manage Your Account Page will also allow the user to change ad space default settings, selecting from the Affiliate Link Library page.
   The advertisement-bidding/affiliate link structure page may comprise:
1. Allows master user (site owner) to “take over” all advertisement spaces with a single ad, ads customized to the different spaces, or affiliate links;
2. Each user page can have advertisements that are assigned to an affiliate link/image (or flash/video) via a rotational system and/or keyword-impacted placement on each “User page;”
3. Each user can have the option of selecting alternative advertisements from the “Affiliate Link Library” to replace any of the affiliate images that would automatically populate on their site to fill up any ad space does not sell. The “Affiliate Link Library” would also be an external page that shows all the affiliate links that are also connected with each user's back-end account management site;
4. If the ad space does sell, then the user gets paid a percentage of the ad space sale. If the affiliate link generates revenue, then the user also gets paid a percentage of the dollars paid by the affiliate. If the user is a paid user, then they would also get paid a percentage of the affiliate/advertisement dollars that come in from every “Question page” where that user is the person who asked the question;
5. The master account holder will also have the option of going and changing the settings for any individual ad-bidding widget, or creating “clusters” of ad-bidding widgets that are identified by certain characteristics (e.g., keywords on the page), and changing the settings of those clusters as a single-time or recurring incident with various pattern options; and
6. In the “Manage Your Account Page,” the user will be able to see what their affiliate advertisement options are (“random,” or user-selections that can be one-time or recurring). The user will also be able to see all bids on their ad space current and in the past, as well as the advertisement dollars and revenue dollars that they have earned on each ad space (which they should be able to see different aggregations based on time frames that they can set, e.g., how much revenue did X space generate from Y date to Z date, and from advertising vs. from affiliate payments.
   The affiliate link library page may comprise:
1. Set of affiliate links and images that are assigned to pages based on keywords with a default random pattern set based on sites without enough data points; and
2. Users can select “default” affiliate links to replace the random placement of affiliate links into open spaces that do not sell.

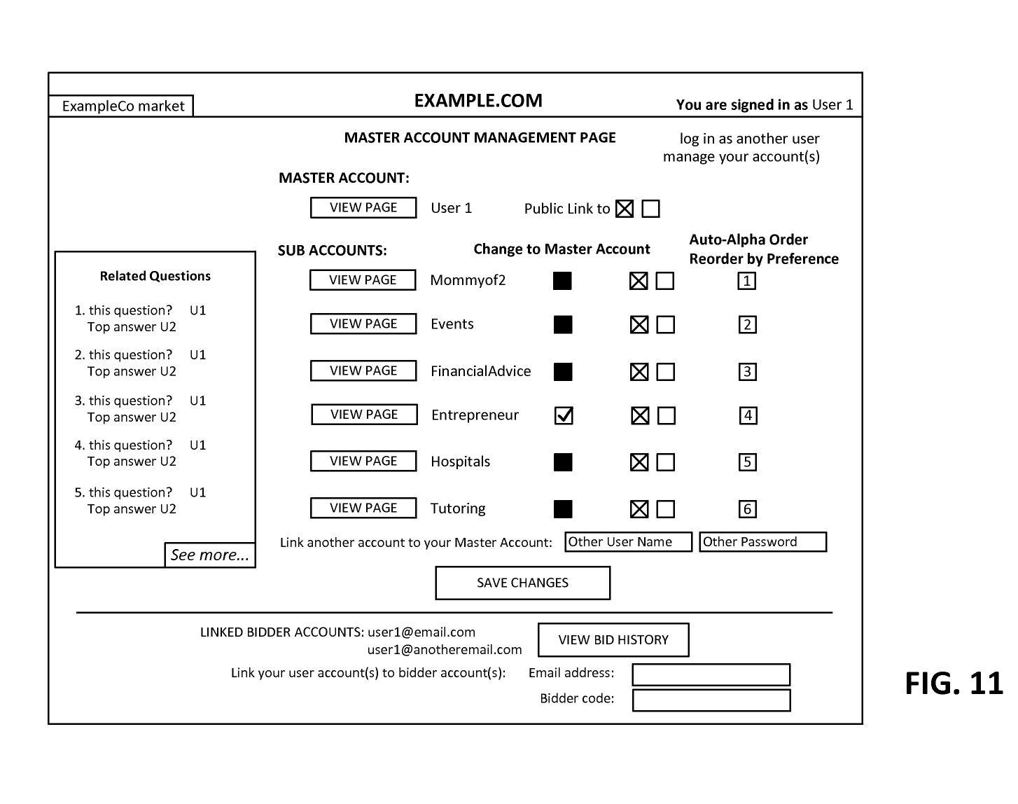

FIG. 11 presents an individual account management page of the admin website. The individual account management page may be displayed at the graphical user interface and may comprise:
1. Change individual settings for each User Account;
2. Be able to Upgrade Individual User Account Levels;
3. Link to other accounts publicly so that linked accounts will show on each user page view; and
4. Link individual User Accounts to social networks such as Facebook, Twitter, and/or LinkedIn.

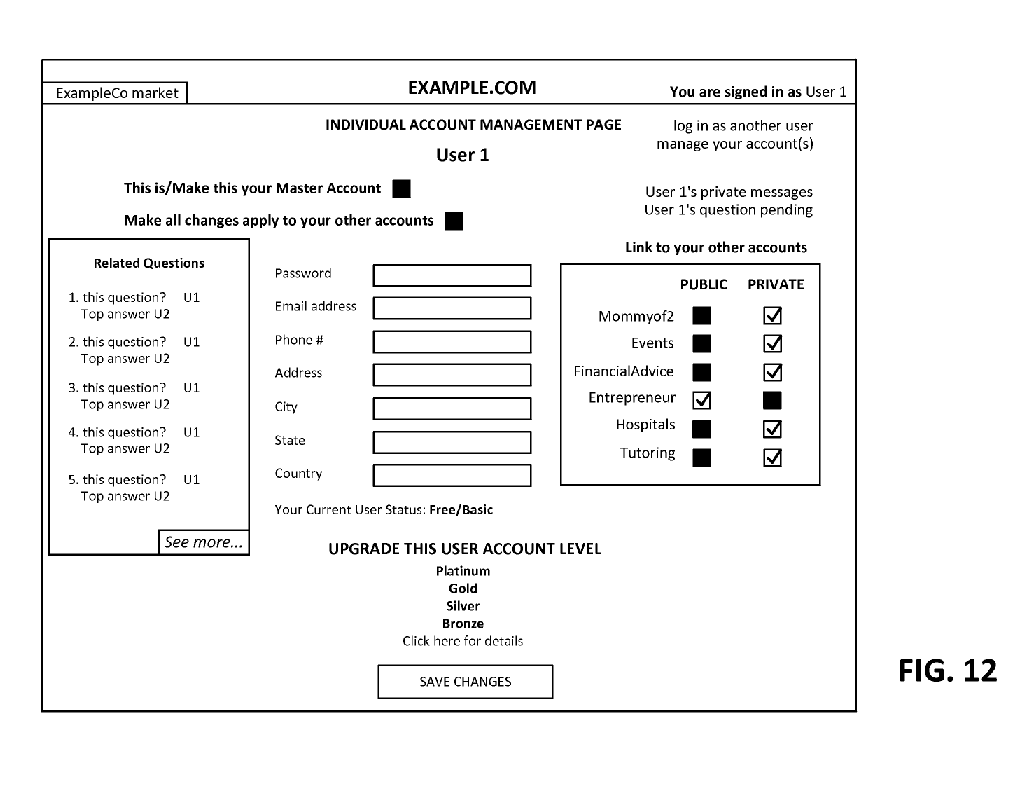

FIG. 12 presents a user account levels page of the admin website. The user account levels page may be displayed at the graphical user interface and may comprise a description of various user account levels. The description may list a number of user accounts, a number of bidding widgets, a percentage of advertisement amounts earned on a user page and on a Q&A page, a corporate or business account, an advertisement credit, and a cost per level.

Advertisement Widgets

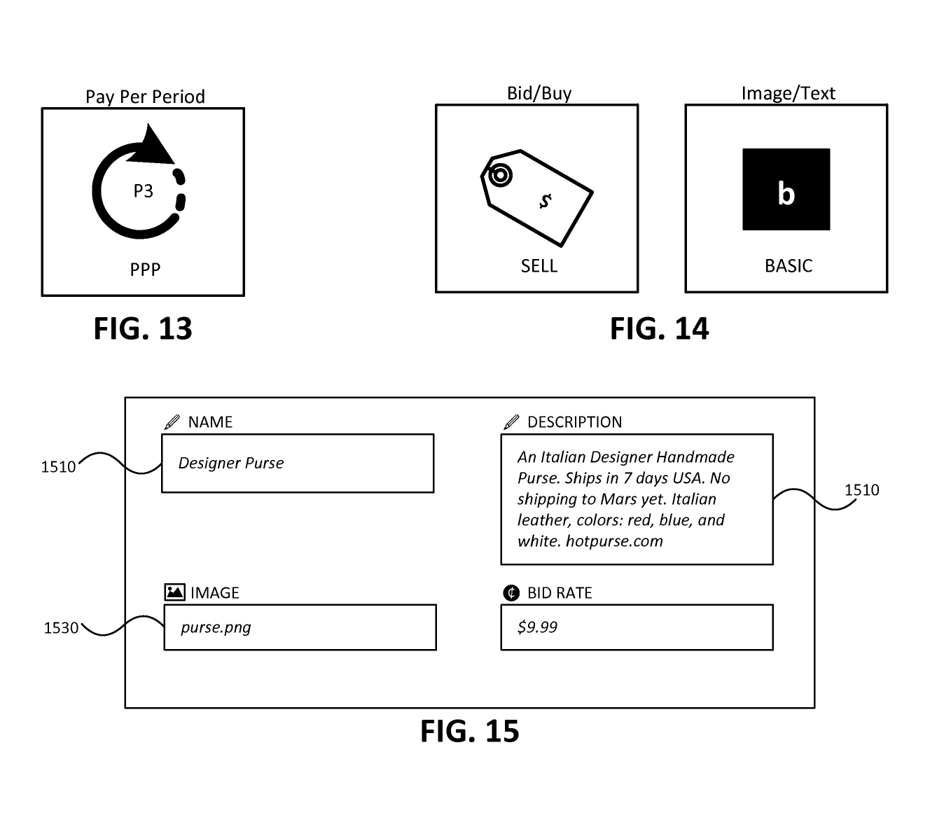

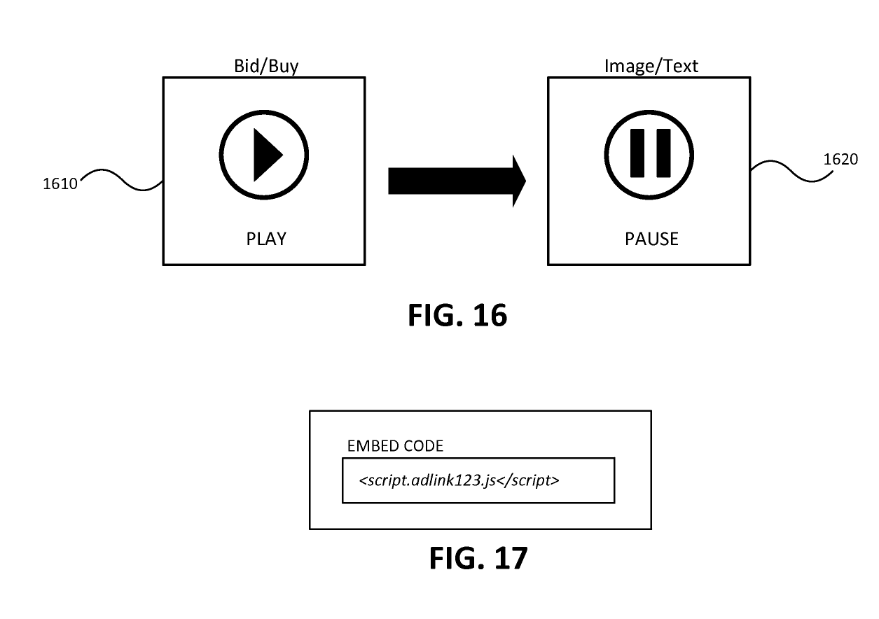

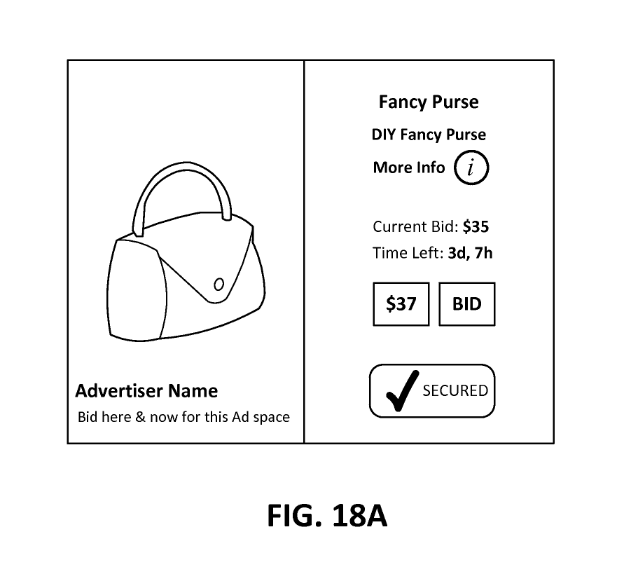

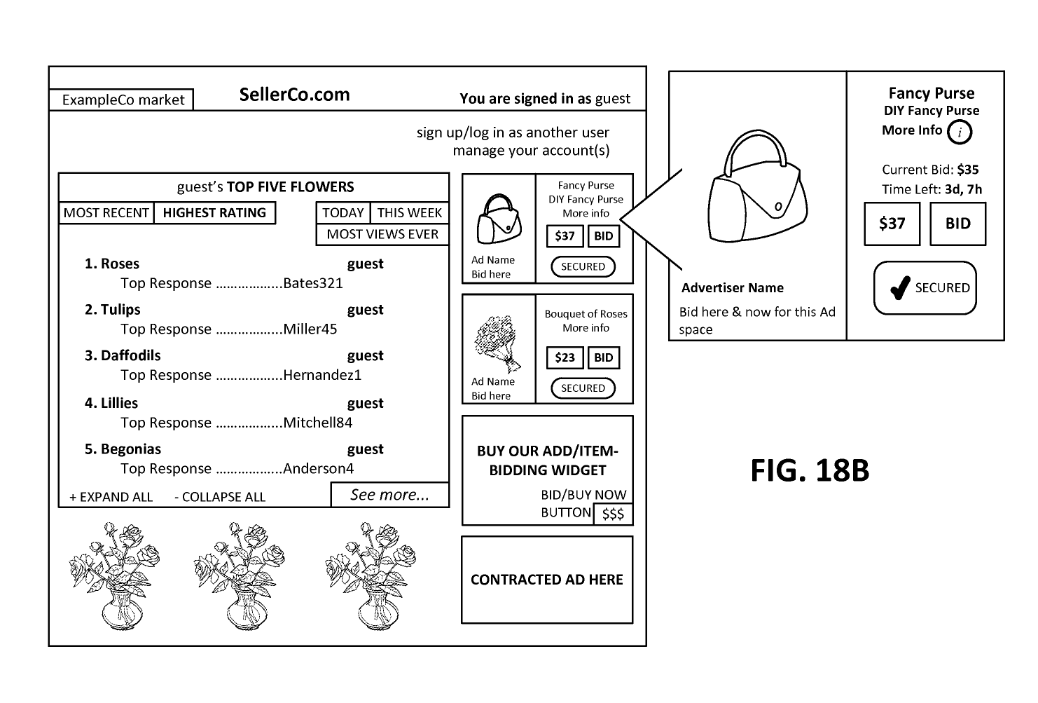

To define an advertisement widget for an item, such as an advertisement space, an item, or a product for sale, a user can execute on a computing device the following steps:
1. User goes to example.com;
2. User signs in/up; and
3. Via a user interface provided by example.com, user chooses advertisement type (e.g., pay per period, bid/buy, image/text, etc.). See FIGS. 13 and 14.
4. User adds a name 1510, description 1520, and image 1530, to the advertisement widget. See FIG. 15. In an embodiment not depicted in FIG. 15, User may also specify keyword tags for the ad to facilitate searching and sorting by topic.
5. User publishes the advertisement widget live via a play button 1610. The play button 1610 then becomes a pause button 1620. See FIG. 16.
6. The user is then given an embed code to use, such as an HTML or Java script that can be added to the user's website. See FIG. 17.
7. Once the code is embedded, the advertisement widget can be rendered on the user's website. FIG. 18A depicts an example completed advertisement widget. FIG. 18B depicts the advertisement widget of FIG. 18A embedded in an example seller website. The advertisement widget can also be rendered at the admin website.

Various types of advertisements can be defined using widgets, including advertisements posted on external websites, such as the website of the seller, and advertisements posted on the admin website, such as the Q&A webpages, the home page, etc.

The advertisement widget may be defined through an advertisement bidding/buy-now plug-in. Features of the plug-in include:
Basic features:
1. Image would link to another page (could potentially be another page featuring an item that is up for bid);
2. The size of the advertisement will be chosen as the widget is being embedded by the advertisers;
3. Show a count-down of how much time is left to bid for the banner ad space or item;
4. Bid/buy-now text link goes to a description of the item or ad space that is up for bid;
5. Each plug-in will also be tied to a “Winning Bidder” for an X amount of time, also can be changed by Master User(s); and
6. Bids and purchases need to be handled through a central merchant account, so that the administrator can act as a “middleman” and pay out a percentage to users who generate advertisement sales, as well as keep a percentage of sales made by Sellers.
Advertisement analytics:
1. Track all purchases that are made through the plug-ins;
2. Winning bidders will be able to view their own tracked activity. (Archived advertisements could show up in the search “forever”—an additional incentive for advertisers to place advertisements);
3. Prospective bidders will be able to view tracked activity based on what they are looking to buy; and
4. Track all clicks on the bid/buy-now plug-ins (clicks on images and bidding/buy now links). Clicks will be logged in a database and then displayed either as emailed reports to the admin(s) or available online at the admin website. Analytics will also be able to be viewed for ad owners/admins in a summarized version on/inside the actual widget.
Customizable elements:
   a. Master User(s) will be able to change what shows (starting bids or buy-now prices, time counters, links, descriptions, etc.) across all plug-ins;
   b. Plug-ins will have “tags” so the “Master User” can change them in aggregate, or change;
   c. Specific types of plug-ins based on how they are tagged; and
   d. Allow percentages to be adjustable for various plug-ins based on type (e.g., non-profits vs. businesses).
Additional features:
1. Allow the administrator to have an overall network view that shows where advertisements are placed so administrator can help sell them. (Ability for the administrator to purchase advertisements on behalf of users who have a “budget”—versus smaller merchandisers who may just want to place an advertisement on their own user page/question page or own website);
2. Allow users to share widgets on Facebook, Twitter, LinkedIn, Pinterest, etc;
3. Incorporate a Shopping Cart to make multiple item purchases easier; and
4. Allow advertisements from web services like Living Social or other deal platforms.

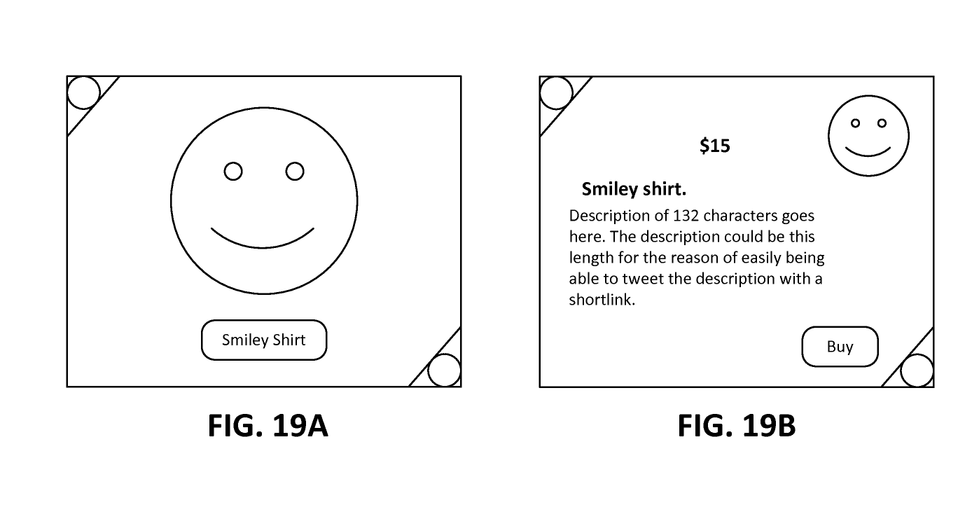

A widget can show either a text description and/or an image with a static price. FIG. 19A shows an initial ad; FIG. 19B shows an ad after clicking on the initial ad of 19A. Various shapes can also be defined by a widget. For example, the widget may support content in three standard web advertisement sizes (e.g., “Button” 125 pixels by 125 pixels, Small Square (200×200) and Square (250×250)). The widget will feature interactive and “multiplayer” features of real-time bidding for the product/advertisement space. Users will be able to visit a site with a widget and engage with its features either by logging in via Facebook or other authorization services. Browsing the widget's information can be done anonymously. The user, once logged in, can then engage the widget and participate in the real time bidding/purchasing.

The user may define various features of a widget, including:
1. Users will have the option to assign different shapes to the Interactive/ad space (e.g., circle, oval, star, triangle, hexagon, octagon, and/or amorphous shapes or outlines that can be drawn by the user who is creating their advertisement/plug-in);
2. 3-D Advertisements (3-D glasses are used to view special images within the plug-in spaces);
3. Allow for event registrations and sign-ups that can be tracked within the plug-in space (using third-party survey software or allowing users to create their own surveys/polls within the space where they can get paid per response);
4. Machine learning, A.I., and A/B Testing plugin/product to have built in A/B testing, which can be automated via the A.I. to identify the winning A/B iteration via semantics (bookmark semantics) and sampled data to then only display the victor and to then go into more subtle A/B tests inside the victory, tweaking single words if there is “room” and/or if the A.I. thinks it can further improve the advertisement's effectiveness;
5. Integrating with mobile ad systems and creating iPad/iPhone/smartphone versions of the widget for users to create and/or bid and purchase;
6. Incorporating gaming features, including the ability to play a game or test an app within the advertisement itself; and
7. Across the web, allow the Q&A widget to be embedded onto various sites and serve as an interactive “FAQ” page that links directly to ads and e-commerce/chat features.

The admin website can be configured to allow a user to generate an embeddable advertisement. The admin website may allow the user to create from the admin website a “portable”/embeddable advertisement called a widget that the user may use in, for example, the following modes:
1. To sell a tangible digital product (download);
2. To setup a real-time bidding for a product/service;
3. To setup reverse bidding for a product/service; and
4. To embed the ad space as a way to sell/auction that ad space via a Pay-Per-Period model.

All of these modes allow for direct credit card transactions to happen directly inside the widget without ever having to refresh the browser or navigate away from the page. This will make for a more direct/lower-barrier to purchasing a product along with allowing any to take and embed a product anywhere that the portable computer instructions, such as JavaScript, will render on the Internet. Products sold online will no longer be bound to their online stores and products will be purchased without ever having to wait for pages to load. A publisher can also search the content management system or a database thereof for an advertisement he/she wants on his/her website, giving him/her complete control over what advertisement is showing, for how long, etc. These features may allow advertisers to know exactly, in real-time, on which websites are all of their advertisements embedded as well as real-time statistics. Additionally, an API may be provided to allow developers to develop custom layouts/functions/features for their advertisements along with developing applications for other users to be able to use with their widgets.

The advertisement bidding/buy-now plug-in may allow a user to:
1. Change size and type of image/video/text featured in the plug-in. An image would link to another page (could be another page featuring an item that is up for bid or sale);
2. Show a countdown of how much time is left to bid for the banner ad space or item;
3. Bid/buy-now text link goes to a description of the item or ad space that is up for bid;
4. Master User(s) will be able to change what shows (e.g., starting bids or buy-now prices, time counters, links, and descriptions) across all plug-ins;
5. Plug-ins will have “tags” so the “Master User” can change them in aggregate or change specific types of plug-ins based on how they are tagged;
6. Each plug-in will also be tied to a “Winning Bidder” for X amount of time, this also can be changed by Master User(s);
7. Track all clicks on the bid/buy-now plug-ins (clicks on images and bidding/buy now links);
8. Track all purchases that are made through the plug-ins. (The tracking system is a separate propriety platform for managing any activity that happens through the plug-ins.);
9. Winning bidders will be able to view their own tracked activity;
10. Prospective bidders will be able to view tracked activity based on what they are looking to buy;
11. Bids and purchases need to be handled through a central merchant account, so an administrator, such as ExampleCo, can act as a “middleman” and pay out a percentage to ad buyers or as space sellers, such as BuyerCo or SellerCo, who generate ad sales, as well as keep a percentage of sales made by sellers;
12. Allow percentages to be adjustable for various plug-ins based on type (e.g., non-profits vs. businesses); and
13. Include a reverse-bidding feature/“Make an Offer” for “Wanted” ads and “group-buying” elements and include escrow accounts as an option for payment.

A user can set-up a widget by operating his or her computer device to:
1. Identify if a widget is for an Item or an Ad Space;
2. Upload/Select an Image for the Item or the Default Ad Image;
3. If the widget is for an Item, set time for when the Item bidding will expire (or if buy now, how many items available—or if it's a reverse auction or if “Make an Offer” feature is allowed)—check Product/Service/Donation; a user can also upload additional photos to showcase item;
4. If the widget is for ad space, set time for how long the winning bidder will get his/her ad to show, and if the bidder can set automated recurring bids (set ad to show previous winning bidder as “default image” if not sold—or allow “bulk” buying of ad space for extended periods of time);
5. User creates key words associated with the Item or the Ad, as well as a description to show up on the widget bid/buy page, including zip code or other location information (e.g. state, country);
6. Set a “starting bid” price (or buy now/make an offer limit);
7. Pay a value or use admin website credits to get the “Powered by Administrator” line removed;
8. Check off that user agrees to terms of service and enters a security code;
9. Code gets generated for each widget that allows the user to embed anywhere on a web-based resource such as a website; and
10. Created widget gets automatically populated into the content management system.

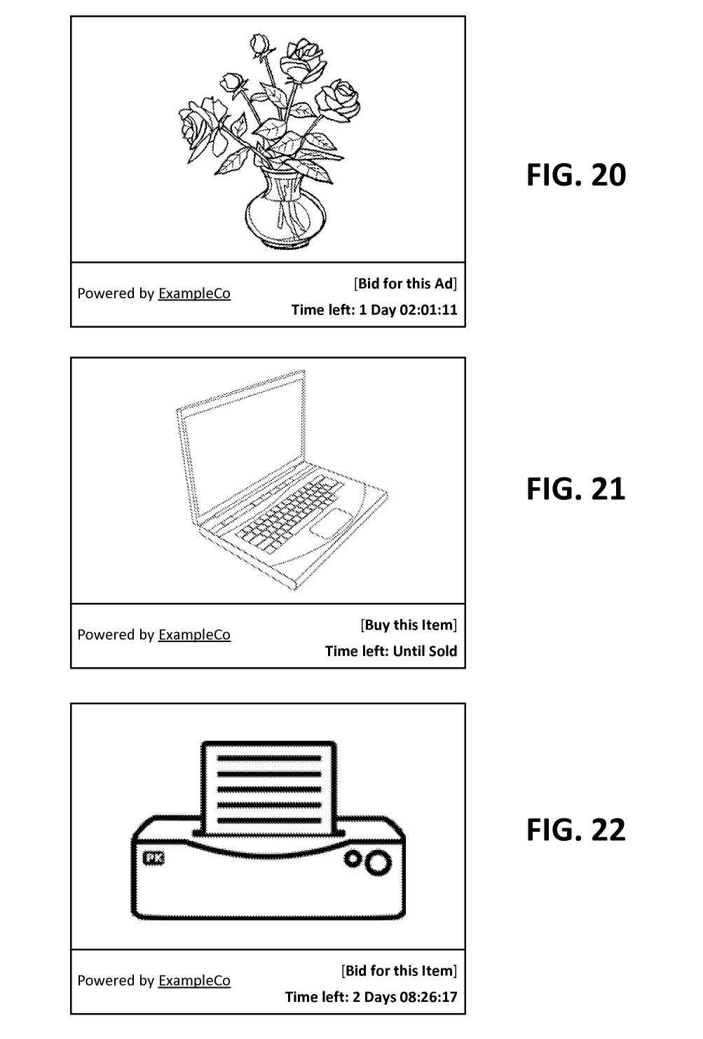

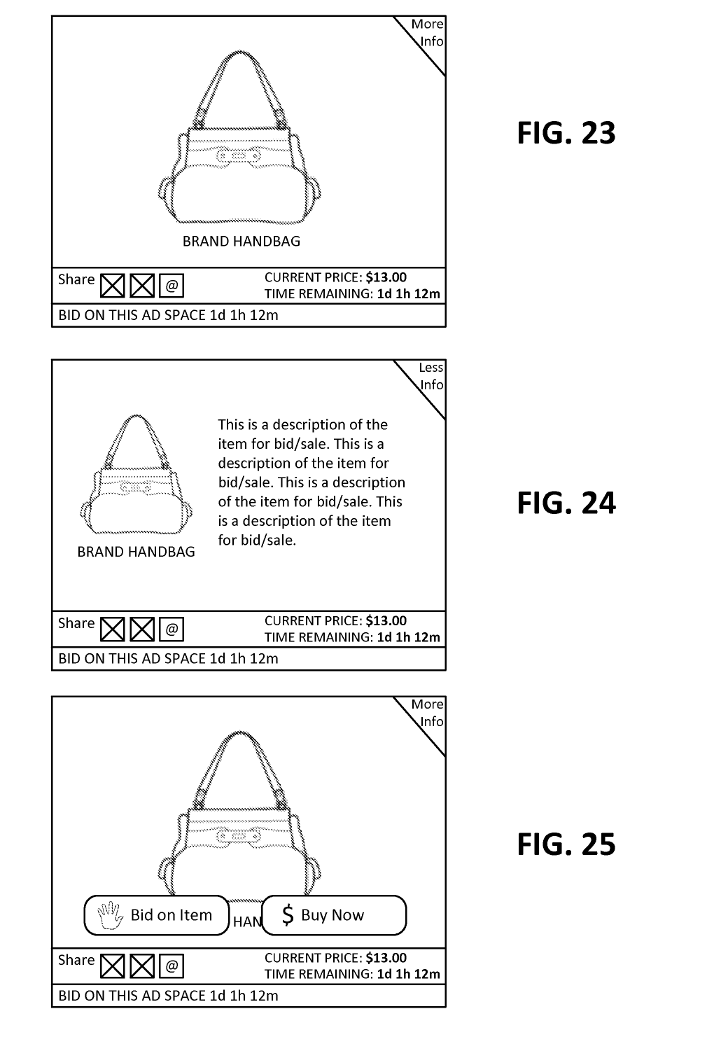

Example embodiments of ad widgets are described below, including example embodiments for auctions and buy-now sales, and embodiments for sale of physical items as well as ad space. Example UI embodiments of these widgets are depicted in FIGS. 20-49. Note that there are effectively two separate ads in each of FIGS. 23-49: one selling or auctioning a handbag on top, and the other in the small horizontal strip on the bottom, auctioning the ad space occupied by the handbag ad above. Note also that all UI elements in these embodiments, including interactive UI elements, are entirely contained with the frame of the ad widget (the ad frame), and will not visually invade the surrounding or containing UI. The containing UI might be, for example, a webpage of seller's SellerCo.com website, the UI built into a computer operating system, or the UI of an application installed on a computer. The ad frame, or portion of the containing UI, would be the space reserved as ad space to contain the widget within the webpage, operating system UI, or application UI. In other embodiments, UI elements of these widgets may be only substantially contained instead of entirely contained within the frame of the ad widget, such that there is only a minor or temporary invasion into containing UI. A widget that is substantially within an ad frame boundary will generally not impede a user's visual or interactive access to the containing UI even though the user is interacting with the ad widget's interactive UI elements. A minor invasion in one embodiment may be a 3D shadow effect from on UI elements within the ad frame casting a shadow at least in part outside the ad frame. A temporary invasion in one embodiment may be a drop-down list box, which type of interactive UI element that enumerates options for a user to select amongst, and which may visually breaks across the ad frame boundary, but disappears after the user makes a selection. Note further that while FIGS. 20-49 all depict a rectangular ad frame, the ad frame and the ad space for sale need not be rectangular, but could be any regular or irregular closed shape composed of curved or straight edges.

Various types of widgets may be defined, including a widget for a selling/bidding item or advertisement, a widget for a pay per period sale, and a basic widget for simple image and text advertisements and may incorporate user-defined web code(s) such as HTML, CSS & Javascript codes.

FIG. 20 shows a widget for a pay per period ad space sale. The advertisement image links to an external website, such as a florist's website. Other businesses can bid for this ad space. The florist can automate multiple maximum recurring bids. A default or affiliate ad gets placed if no bid is placed. Keywords are associated with the ad, and the florist's website is added to the admin website's searchable directory of advertisers or “network partners” that is part of the content management system—this ad is given a Unique ID so that it can be tracked and re-used.

FIGS. 21 and 22 show a widget for a selling/bidding on an item (laptop and printer, respectively). The widget can also be configured for a pay-per-period bidding for the ad space on the website. Image of the item links to the administrator internal bid/buy page. This item gets posted on the administrator “Market Central.” Users can bid on the item. The administrator can track if the item is sold on the market central or on an external website. The advertiser allows users to “make an offer” and “reverse” auctions—e.g., having a “WANTED” ad that allows users to try to out-bid each other by undercutting competitor prices or service costs.

A seller can define an item and an ad space for sale through the widget. The definition may include an image of the item (as shown in FIG. 23) and a description thereof (as shown in FIG. 24). The seller may also define the format of the advertisement (and the advertisement space) that the widget will display, such as the shape, size, and background color and transparency. The seller may set up a bidding and buy-now option for the item as well as a bidding option for the ad space (as shown in FIG. 25).

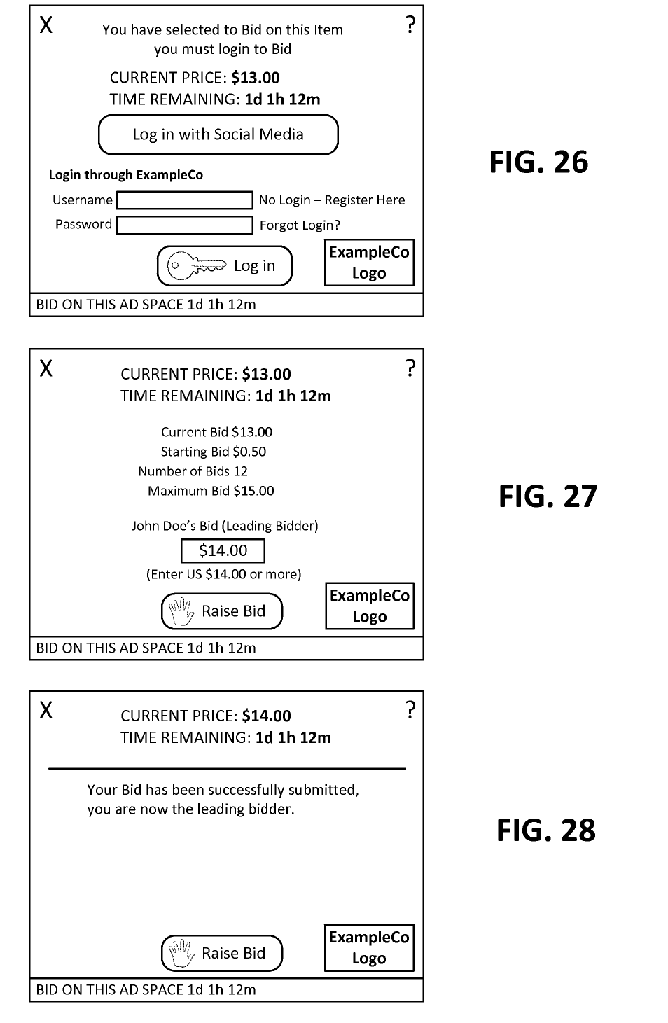

When the bidder selects the “bid on item” option, FIGS. 26-30 may be displayed at the bidder's interface. When the bidder selects the “buy item now,” FIGS. 31-42 may be displayed at the bidder's interface. When the bidder selects the bid on the ad space option, FIGS. 43-49 may be displayed at the bidder's interface. The figures reflect the process followed by the bidder to place a bid on the item, buy the item, or place a bid on the advertisement space. The background of the interfaces may show the seller advertisement based on the color and transparency of the advertisement defined by the seller. FIG. 26 shows a log-in interface that the bidder may use to access the bid on the item option.

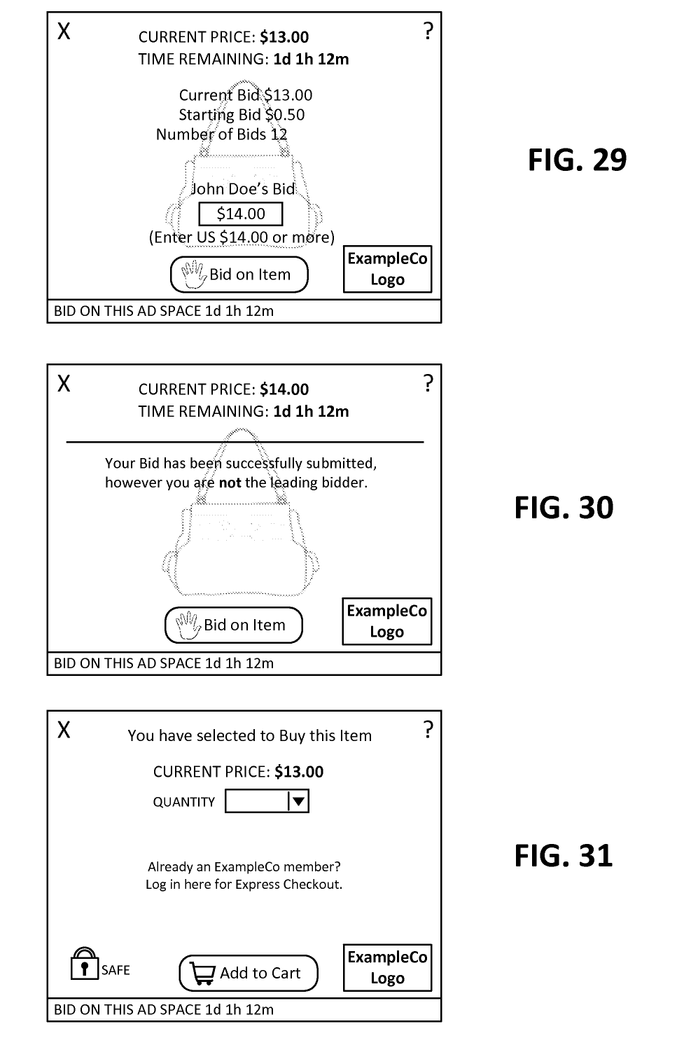

If the bidder was the leading bidder, FIG. 27 shows the leading bidder interface for making a bid, and FIG. 28 shows the leading bidder interface confirmation when a bid is made. Once the bid is confirmed, the interface may be redirected to the bidding interface or to the advertisement. If the bidder was not the leading bidder, FIG. 29 shows the bidder interface for making a bid and FIG. 30 shows the bidder interface for the resulting bid.

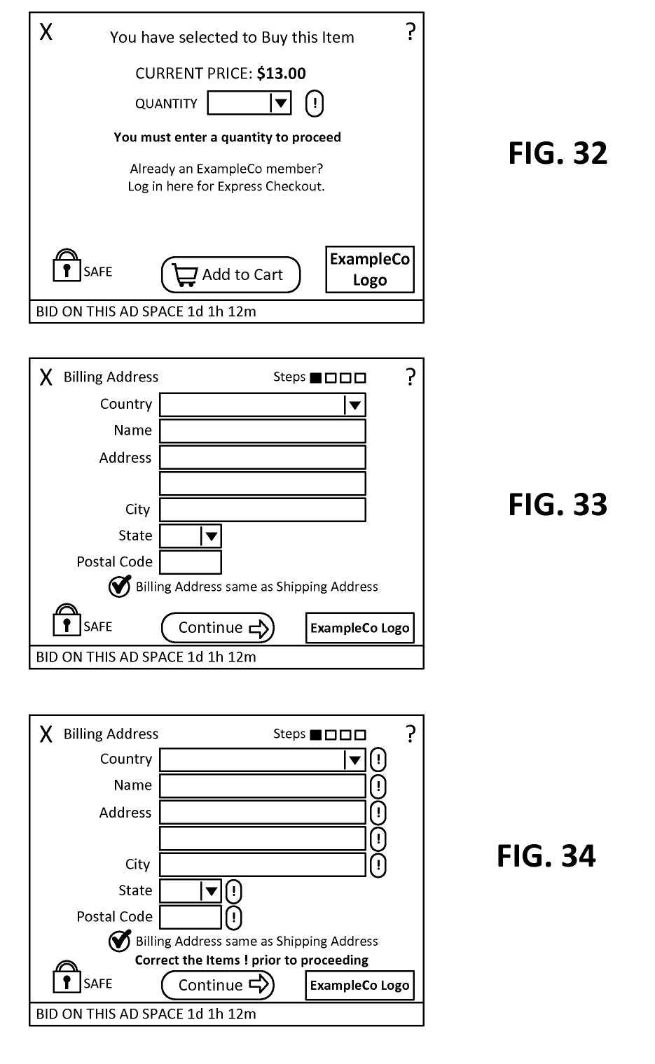

FIG. 31 shows the interface to a bidder (or buyer) that selects the buy item now. FIG. 32 shows an error message displayed when an error is entered at the interface of FIG. 31.

FIG. 33 shows the first step in the check-out process, which allows entry of a billing address after the buyer properly adds a quantity of the item to his or her shopping cart in FIG. 31. FIG. 34 shows an error message displayed when an error is entered at the interface of FIG. 33.

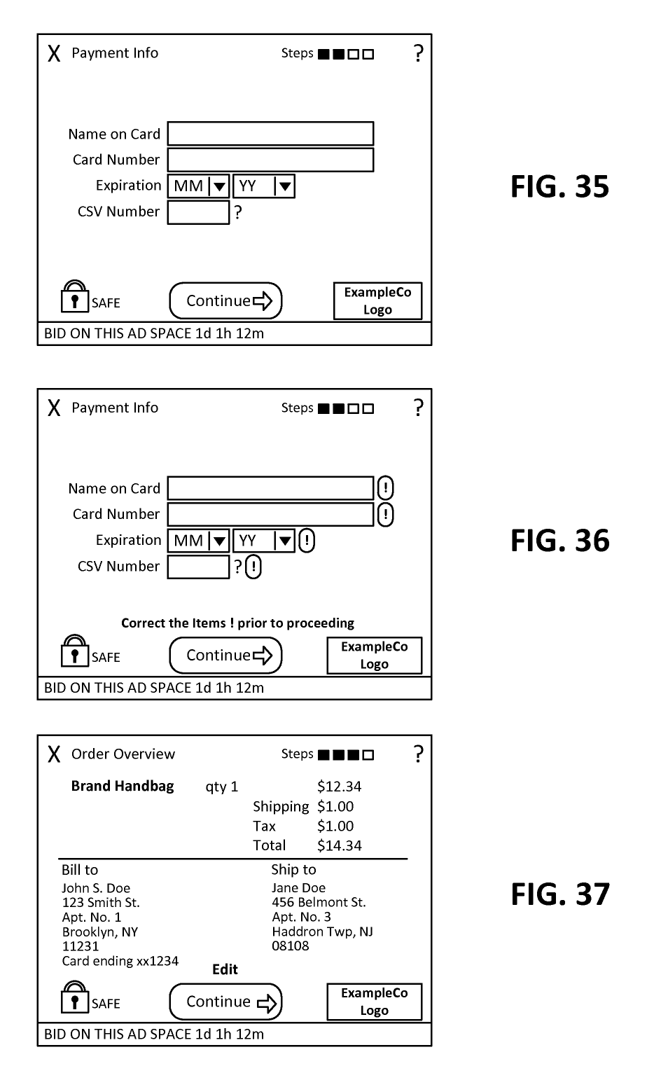

FIG. 35 shows the second step in the check-out process, which allows entry of payment information. FIG. 36 shows an error message displayed when an error is entered at the interface of FIG. 35.

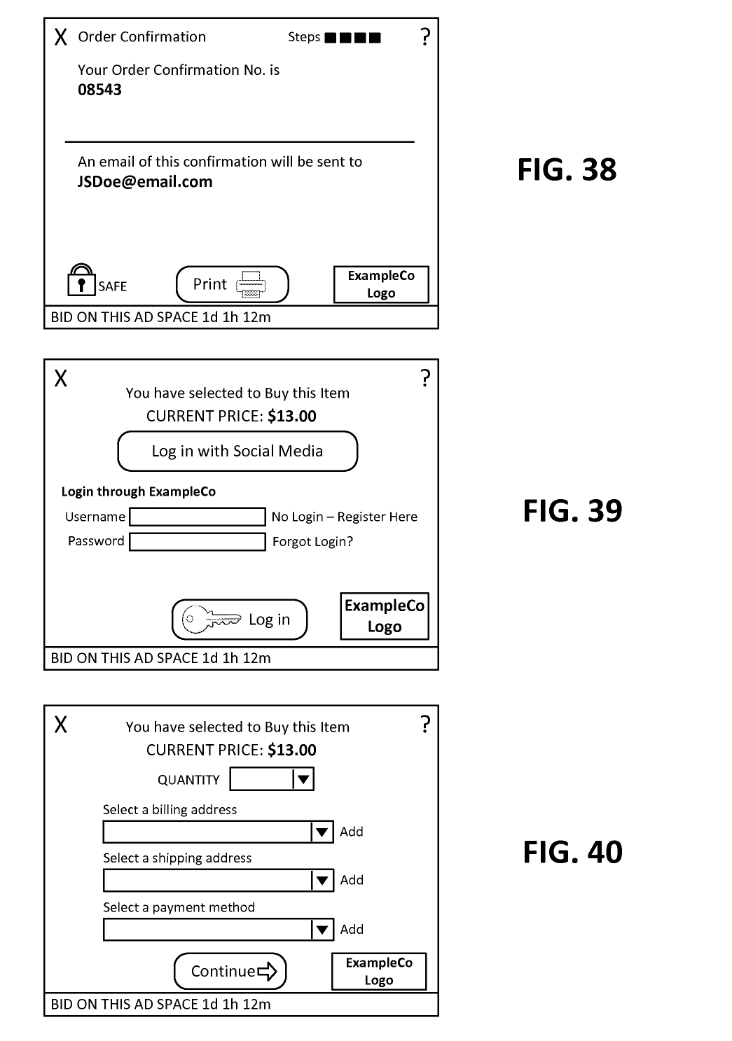

FIG. 37 shows the third step in the check-out process, which provides an order overview. FIG. 38 shows an order confirmation step in the check-out process.

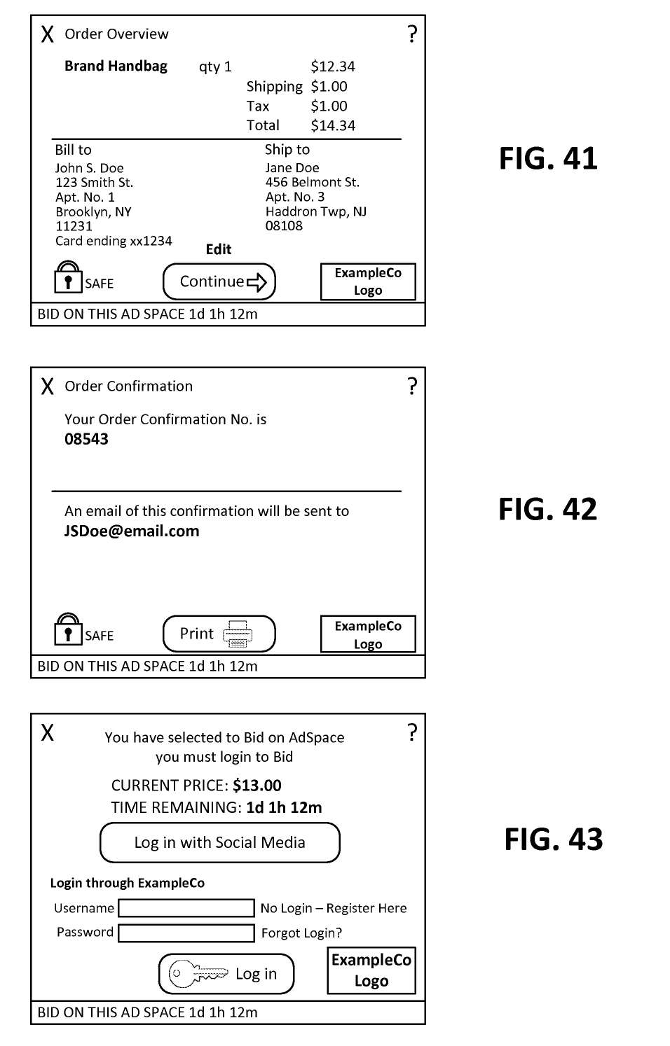

An express check-out process may also be available to the buyer as shown in FIGS. 39-41. FIG. 39 shows an express log-in interface. FIG. 40 shows an interface for a first step in the express checkout. FIG. 41 shows an interface for a second step in the express check-out, which includes an order overview. FIG. 42 shows an interface for an order confirmation step in the express check-out.

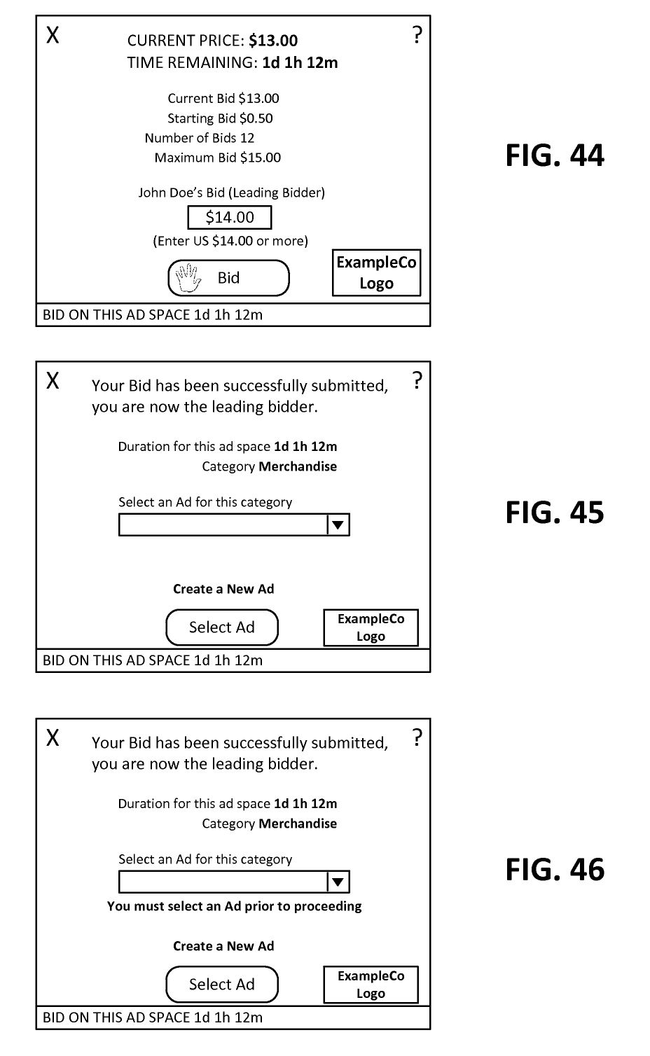

FIG. 43 shows the interface to a bidder that selects the bid on the ad space option. The interface may include a log-in page. If the bidder is the highest bidder, FIGS. 44-47 may be displayed to the bidder. Otherwise, FIGS. 48-49 may be displayed.

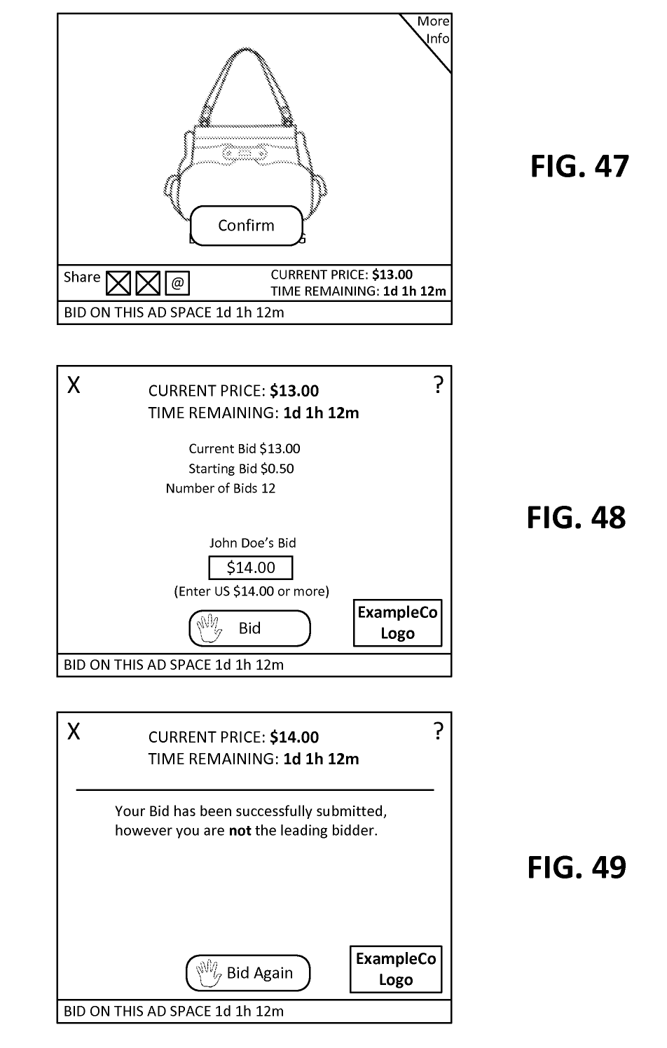

If the bidder was the leading bidder, FIG. 44 shows the leading bidder interface for making a bid; FIG. 45 shows the leading bidder interface for selecting an advertisement; FIG. 46 shows an error page when an advertisement is improperly selected; and FIG. 47 shows the leading bidder interface confirmation when a bid is properly made. If the bidder was not the leading bidder, FIG. 48 shows the bidder interface for making a bid and FIG. 49 shows the bidder interface for the resulting bid.

If an item is for sale/bidding, the description of the item will show up with any additional uploaded photos. For buy now items, the user can:
1. Purchase the item at a set price, until inventory is 0;
2. Make an offer on items will notify the seller that an offer has been made, and it can be accepted automatically or be “pending” given a manual approval; and
3. Bid items will show the time left to bid and increase incrementally based on a prior bid/start price.
   The winning bidder will be notified to buy, and get redirected to a Buy Page (i.e., ask for payment information prior to when bidding closes to ensure payment). If an ad space is for sale, the description of the ad space will show up, and business would be able to bid for the ad space in the same or a similar way the Bid Page works for Product/Service items.

Additional Administrator Features

In addition to generating and managing widgets, the administrator may manage the Q&A webpages. Features of the Q&A webpages include:
1. Robust search functionality;
2. Rating system (evolving into gamification features, e.g., giving registered users ad credit);
3. Filtering system to show the Top 5 most viewed, highest rating, etc., on the home page;
4. Anonymous users (allowing guests to ask/answer questions without logging in);
5. Allow multiple accounts and toggling between views of accounts as well as viewing in aggregate;
6. Link accounts into any bidder accounts (single master email address for primary account allowing multiple email addresses to be added):
   a. Bidder in accounts would have additional Terms of Service.
   b. Adding credit cards to bidder accounts.
7. Integrate the ad-bidding and plug-in functionality into the Question & User pages, allowing for both overall and account-level tracking;
8. Incorporate an “affiliate library” of links that would automatically populate spots that are not sold (tie into ad networks and ad exchanges):
   a. Create a Plugin that interfaces with the ClickBank API and others to fill ad spaces when a user buys ads that aren't available for a specific keyword.
9. Allow network partners to be easily added to the affiliate library (e.g., as static plug-ins).

Advertisements or widgets for advertisements that define an item or an ad space for selling or bidding can be managed in a marketplace or classified section of a content management system (CMS). The marketplace/classified section may use multiple instances of plug-ins and may allow users to easily add a plug-in with pre-set standards to sell items or services and to link to a plug-in “page” with the single instance of the item/service for sale. Product/Service items get listed in the Market Central “Products/Services/Donations” section and will be searchable by location, key words, price, etc. (If the widget is placed on an external site, then content management system may track if the item is sold on the Market Central or on the external site). The advertisements will get listed in the “Network Partner Directory” page of the Market Central and also be searchable.

The content management system may tie in social media elements (e.g., showing faces of people who are bidding on items or give a user the option to bid anonymously or the option of posting on social media services such as Facebook or Twitter when users post comments through their public profiles). The content management system may also allow users to share (e.g., show what items they're bidding on, their Q&A account pages, on Facebook, on Twitter, etc.), may identify “gold level” or tiered services that will be associated with a monthly charge for the user to access (e.g., giving businesses in the directory option to be a “featured affiliate” or receive “custom graphics” for their banner ads), and may provide a social media training platform.

The CMS may include the following features:
1. Asynchronous CMS page loading where the browser does not refresh traditionally, where data is instead “pushed” to the user's browser from the server creating in a faster, more seamless user experience;
2. Server-side shared DOM, S3D for a form of screen sharing requiring no plug-in, etc., but instead just sharing the DOM instance between two users. This brings features like support/sales agents to be able to guide a visitor though the website; also for two visitors to guide each other or to share parts of the website;
3. Voice control plugin to allow users/administrators of the CMS to create/navigate/edit pages/content via voice commands on the website. This will evolve accessibility in CMS along with create a zero barrier CMS, basically nullifying any learning curve. For example, a spoken command: “Create New Page Titled ‘Contact Us;’”
4. “Multi-player” real-time editing of website content using S3D. Multiple users can be at the same time editing pages of the CMS, dragging/dropping creating elements (shapes), changing colors, fonts, styles, copy (text), with access to edit the source code and tweak deeper variables like a traditional code inspector (like Mozilla's “Firebug,” for example) except those tweaks to the source may then be saved into the live or an instance/preview with a generated URL, which may or may not be “public”. These instances can be managed with a git repository option for better management.
5. Offline editing & access of website content;
6. CMS plugin for page specific chat rooms using S3D. For example, a user can access pages of the CMS and login via Facebook and then join either a website global chat or a chat room specific to the users also viewing that page at the same time;
7. Set up administrative user permissions;
8. Overlay interface: admin user interface overlaying public web pages for website administrators to manage edits of pages as well as interact with users viewing said pages;
9. Drag-and-drop capability for text and images;
10. Editing a website via the CMS, dragging and drawing out not only website elements but also advertisements. This allows the advertisement to be designed via the CMS to fit custom dimensions. The advantages are allowing for non-traditional advertisement designs fitting a website's design/layout better as well as creating non-traditional advertisement designs, which will be more engaging and standout more to users than a traditional online advertisement in a traditional location in the website's layout; and
11. Allows various shapes and forms of advertisements.

The software module may also include a powerful search engine that searches external websites, the admin website, the CMS, advertisements, and user info. The search engine may apply quality controls to the searches by, for example, providing relevance or ratings to the search result or incorporating, for a user search, other user searches. The search engine may also draw answers from external websites, including an ability to translate keyword searches to foreign languages and content of foreign websites. The search engine may also use semantics, which may include:
1. Semantic tagging in the CMS supporting the Schema.org semantics and RDF/OWL for both better SEO and better searches in the content management system and the admin website, thus, giving the CMS the ability to ‘understand’ what the website's textual content is and its subject/meta-context;
2. Semantic/ontologic indexing of ad seller websites for very specific, pin-point accuracy of the widget advertisement network to allow advertisers and publishers to search the widget advertisement network, providing better accuracy and true support for long-tail searches;
3. Semantic/ontologic indexing of widget advertisement content; and
4. Semantics/ontologic indexes leveraged for Machine Learning/A.I. “Re-targeting 3.0” making for a smarter widget advertisement network and greater return on investment (ROI) for advertisers as well as displaying ads that “fit” with the user/potential customer/website visitor.

The software module may also allow real social media ROI tracking from end-to-end via a holistic, integrated campaign management system. These social campaign tracking features may be tied with the payment gateway to send invoices and receive payments, tying the social campaign data down to the payment received. Additional features provided by the software module include:
1. A feature that allows users to give feedback/rate ads for visual quality, content, and the like;
2. A feature that, when a user is creating a widget, runs an algorithm that assess—the ad and rates it as well as give suggestions/examples of similar ads in the system that have done well;
3. A feature that allows users to set a schedule of companies/products they want to feature in their ad spaces for free and then set the percentage of revenue they take of products sold on their website via those selected Ads spaces;
4. A feature that allows custom bidding pages showing all the widgets in real-time that a broker is bidding on. When mousing over, the feature shows a transparent screen shot of where the ad is placed on the embed website in the background of the custom bidding page;
5. A feature that offers a marketplace of ad designers to design quality ads for users;
6. A feature that allows COMPANY currency/credit transfer from account to account.

### Embodiments

Several embodiments are disclosed in this section.

A first example embodiment is a computer implemented method for conducting an electronic transaction by a client computer wherein the client computer is communicatively coupled to an advertisement administrator server, the method comprising: presenting, on the client computer, an advertisement user interface (UI) substantially within an advertisement frame delineating a UI of the advertisement from a UI surrounding the advertisement; presenting, substantially within the advertisement frame, a current purchaser or bid price for a product or service indicated by the advertisement, the current purchase or bid price provided by the advertisement administrator server; receiving, via UI elements rendered substantially within the advertisement frame, user identity credentials from a user and transmitting the received identity credentials to the advertisement administrator server; receiving, via the UI elements, a selection of a payment method and communicating the received selection to the advertisement administrator server; and receiving, via the UI elements, confirmation of a purchase or bid from the user and communicating the confirmation to the advertisement administrator server.

In a variation of the first example embodiment, the method is further comprising: authenticating the unique user identity credentials with a third-party authentication system. Another variation is the first example embodiment further having the advertisement is for advertisement space, the method further comprising presenting, substantially within the advertisement frame, an indication of where the advertisement space is located.

A second example embodiment is a non-transitory computer readable storage medium comprising instructions for an advertisement unit that, when executed on a system, cause the system to at least: generate a user interface (UI) operative for the advertisement unit, wherein the UI is generated within a portion of a containing UI; and indicate, within the UI, a product or service available for a related electronic transaction, the UI including one or more of text, a static image, or an animated image; wherein the UI is operative to effectuate the related electronic transaction using UI elements contained substantially within the portion of the containing UI and without substantially changing or disturbing the containing UI.

A variation of the second example embodiment is the computer readable storage medium wherein the related electronic transaction is a purchase. In an alternate variation, the related electronic transaction is a bid in an auction or a reverse auction. Another variation of the second example embodiment is an embodiment wherein the user is identified using a third-party authentication system.

Another variation of the second example embodiment is an embodiment wherein the product or service available is a rental or sale of advertising space within the containing UI. Variations of this variation include an embodiment wherein the portion of the containing UI includes the available advertising space, and include an embodiment where the available advertising space is automatically filled with an advertisement specified by the user after completion of the related electronic transaction.

A third example embodiment is a system for generating a portable advertisement unit capable of an ecommerce transaction, the system comprising a computer device comprising at least one processor communicatively coupled to at least one memory and at least one storage device, and the at least one memory further comprising computer instructions that when executed by the at least one processor, cause at least generating portable computer instructions for a user interface (UI) that, when executed, cause at least: rendering, substantially within a frame of the UI, an advertisement for a product or service, wherein the frame defines a portion of a containing UI within which the advertisement unit UI is rendered; rendering, substantially within the frame, a current purchase price or bid price for the product or service; accepting, substantially within the frame, user identity credentials from a user; accepting, substantially within the frame, a selection of a payment method by the user; and accepting, substantially within the advertisement frame, confirmation of a purchase or bid from the user.

A variation is the third example embodiment wherein the system is an advertisement administrator server and the portable advertisement unit, and wherein, when the portable computer instructions are executed on a user computer, the at least one memory further comprises computer instructions that when executed by the at least one processor, cause at least: providing, to the user computer, the current purchase price or bid price; accepting, from the user computer, the user identity credentials; accepting, from the user computer, the selected payment method; and accepting, from the user computer, the confirmation. Another variation is the third example embodiment wherein the portable computer instructions are operative to communicate with a transaction server, when the portable computer instructions are executed on the user computer, cause at least: receiving, from the transaction server, the current purchase price or bid price; transmitting, to the transaction server, the unique user identity credentials; transmitting, to the transaction server, the selected payment method; and transmitting, to the transaction server, the confirmation. An additional variation includes the system of the third example embodiment wherein the product or service is a rental or sale of advertising space that is located somewhere within the containing UI. A variation of the additional variation is where the frame is identical to the frame of the advertising space for rental or sale.

A fourth example embodiment is an administering system for administering Internet advertisements, the system comprising a computing device comprising at least one processor communicatively coupled to at least one memory and at least one storage device, the at least one memory further comprising computer instructions that when executed by the at least one processor, cause at least: changing an ad presented on a website at a first time, wherein the website includes website instructions that reference the administering system to determine content of the ad; and process electronic transactions initiated by interaction with the ad of users of the website.

A variation of the fourth example embodiment is wherein the electronic transactions include sales of an ad space on the web site and the electronic transaction is a purchase of the ad space or bidding on the ad space. Another embodiment of this variation is where the ad space for sale is the space currently occupied by the ad.

Another variation of the fourth example embodiment is where the computer instructions additionally cause the ad to be removed at a second time. And yet another variation is where the computer instructions additionally track viewing and user interaction of the ad, and accordingly calculate division of fees and revenues.

Computing System

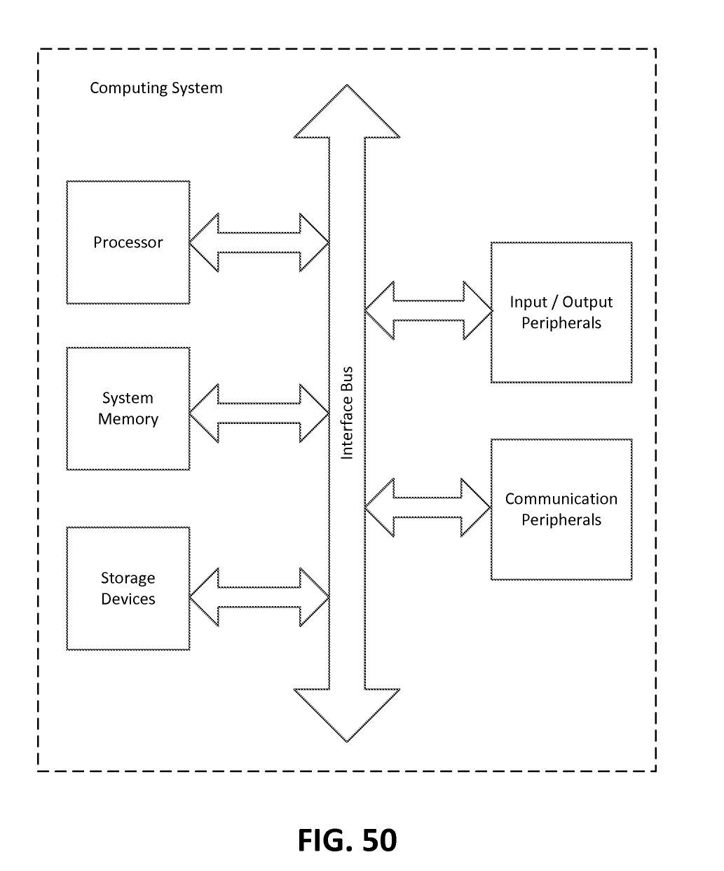

FIG. 50 depicts an example computing system, and could represent, for example, the ad administrator computer, a buyer's computer, or the seller's computer. In a basic configuration, the computing system may include at least a processor, a system memory, a storage device, input/output peripherals, communication peripherals, and an interface bus. The interface bus is configured to communicate, transmit, and transfer data, controls, and commands between the various components of computing system. The system memory and the storage device may comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may be connected to the processor through any of the ports coupled to the interface bus. Finally, the communication peripherals are configured to facilitate communication between the computing system and other computing devices over a communications network. The communication peripherals include, for example, a network interface controller, modem, various modulators/demodulators and encoders/decoders, wireless and wired interface cards, antenna, and the like.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed:

1. A computer implemented method for conducting an electronic transaction by a client computer wherein the client computer is communicatively coupled to an advertisement administrator server, the method comprising:
presenting, on the client computer, an advertisement user interface (UI) substantially within an advertisement frame delineating a UI of the advertisement from a UI surrounding the advertisement;
presenting, substantially within the advertisement frame, a current purchaser or bid price for a product or service indicated by the advertisement, the current purchase or bid price provided by the advertisement administrator server;
receiving, via UI elements rendered substantially within the advertisement frame, user identity credentials from a user and transmitting the received identity credentials to the advertisement administrator server;
receiving, via the UI elements, a selection of a payment method and communicating the received selection to the advertisement administrator server; and
receiving, via the UI elements, confirmation of a purchase or bid from the user and communicating the confirmation to the advertisement administrator server.

2. The method of claim 1, further comprising: authenticating the unique user identity credentials with a third-party authentication system.

3. The method of claim 1, wherein the advertisement is for advertisement space, the method further comprising presenting, substantially within the advertisement frame, an indication of where the advertisement space is located.

4. A non-transitory computer readable storage medium comprising instructions for an advertisement unit that, when executed on a system, cause the system to at least:
generate a user interface (UI) operative for the advertisement unit, wherein the UI is generated within a portion of a containing UI; and
indicate, within the UI, a product or service available for a related electronic transaction, the UI including one or more of text, a static image, or an animated image;
wherein the UI is operative to effectuate the related electronic transaction using UI elements contained substantially within the portion of the containing UI and without substantially changing or disturbing the containing UI.

5. The computer readable storage medium of claim 4, wherein the related electronic transaction is a purchase.

6. The computer readable storage medium of claim 4, wherein the related electronic transaction is a bid in an auction or a reverse auction.

7. The computer readable storage medium of claim 4, wherein the user is identified using a third-party authentication system.

8. The computer readable storage medium of claim 4, wherein the product or service available is a rental or sale of advertising space within the containing UI.

9. The computer readable storage medium of claim 8, wherein the portion of the containing UI includes the available advertising space.

10. The computer readable storage medium of claim 8, wherein the available advertising space is automatically filled with an advertisement specified by the user after completion of the related electronic transaction.

11. A system for generating a portable advertisement unit capable of an ecommerce transaction, the system comprising a computer device comprising at least one processor communicatively coupled to at least one memory and at least one storage device, and the at least one memory further comprising computer instructions that when executed by the at least one processor, cause at least:
generating portable computer instructions for a user interface (UI) that, when executed, cause at least:
rendering, substantially within a frame of the UI, an advertisement for a product or service, wherein the frame defines a portion of a containing UI within which the advertisement unit UI is rendered;
rendering, substantially within the frame, a current purchase price or bid price for the product or service;
accepting, substantially within the frame, user identity credentials from a user;
accepting, substantially within the frame, a selection of a payment method by the user; and
accepting, substantially within the advertisement frame, confirmation of a purchase or bid from the user.

12. The system of claim 11, wherein the system is an advertisement administrator server and the portable advertisement unit, and wherein, when the portable computer instructions are executed on a user computer, the at least one memory further comprises computer instructions that when executed by the at least one processor, cause at least:
providing, to the user computer, the current purchase price or bid price;
accepting, from the user computer, the user identity credentials;
accepting, from the user computer, the selected payment method; and
accepting, from the user computer, the confirmation.

13. The system of claim 11, wherein the portable computer instructions are operative to communicate with a transaction server, when the portable computer instructions are executed on the user computer, cause at least:
receiving, from the transaction server, the current purchase price or bid price;
transmitting, to the transaction server, the unique user identity credentials;
transmitting, to the transaction server, the selected payment method; and
transmitting, to the transaction server, the confirmation.

14. The system of claim 11, wherein the product or service is a rental or sale of advertising space that is located somewhere within the containing UI.

15. The system of claim 14, wherein the frame is identical to the frame of the advertising space for rental or sale.

16. An administering system for administering Internet advertisements, the system comprising a computing device comprising at least one processor communicatively coupled to at least one memory and at least one storage device, the at least one memory further comprising computer instructions that when executed by the at least one processor, cause at least:
changing an ad presented on a website at a first time, wherein the website includes website instructions that reference the administering system to determine content of the ad; and
process electronic transactions initiated by interaction with the ad of users of the website.

17. The administering system of claim 16, wherein the electronic transactions include sales of an ad space on the web site and the electronic transaction is a purchase of the ad space or bidding on the ad space.

18. The administering system of claim 17, wherein the ad space for sale is the space currently occupied by the ad.

19. The administering system of claim 16, wherein the computer instructions additionally cause the ad to be removed at a second time.

20. The administering system of claim 16, wherein the computer instructions additionally track viewing and user interaction of the ad, and accordingly calculate division of fees and revenues.
